(19) United States
(12) Patent Application Publication
(10) Pub. No.: US 2026/0340921 A1
(43) Pub. Date: Oct. 29, 2026

(54) ZERO-SHOT FRAMEWORK FOR SPEAKING STYLE PRESERVING LIP SYNCHRONIZATION

(71) Applicant: ADOBE INC., SAN JOSE, CA (US)

(72) Inventors: Vishal Babu Bhavani, Shankarpalle (IN); Saurabh Purohit, Bengaluru (IN); Nisheeth Lahoti, Bengaluru (IN); Rahul Dandwate, Bengaluru (IN); Yang Zhou, Mountain View, CA (US); Harsh Agarwal, Raipur (IN)

(21) Appl. No.: 19/374,287

(22) Filed: Oct. 30, 2025

Related U.S. Application Data
(60) Provisional application No. 63/793,192, filed on Apr. 23, 2025.

(51) Int. Cl. G06T 13/40; G06T 13/20

(52) U.S. Cl. CPC G06T 13/40; G06T 13/205

(57) ABSTRACT

A method, apparatus, non-transitory computer readable medium, and system for image generation include obtaining an input prompt including speech content. An audio-to-speech-articulation model generates speech articulation features based on the input prompt. The speech articulation features represent a facial expression corresponding to the speech content. A media generation model generates a synthetic image based on the speech articulation features. The synthetic image depicts a face with the facial expression vocalizing the speech content.

### CROSS REFERENCE TO RELATED APPLICATION

This application claims priority under 35 U.S.C. § 119 to U.S. Provisional Application No. 63/793,192, filed on Apr. 23, 2025, in the United States Patent and Trademark Office, the disclosure of which is incorporated by reference herein in its entirety.

### BACKGROUND

The following relates generally to media processing, and more specifically to video processing and image generation using machine learning. Media processing relates to processing media assets of various modalities. For example, media assets may include audio files, video files, image files, natural language files, etc. Digital video/image processing refers to the use of a computer to edit a digital video/image using an algorithm or a processing network. In some cases, video/image processing software can be used for various tasks, such as video/image editing, video/image restoration, video/image generation, etc. Recently, machine learning models have been used in advanced image processing techniques. Among these machine learning models, generative models such as generative adversarial networks (GANs) have been used for various tasks including generating videos/images with perceptual metrics, generating videos/images in conditional settings, image inpainting, and video/image manipulation.

Image generation, a subfield of media processing, involves the use of machine learning models to synthesize images. Machine learning models such as variational autoencoder (VAE) can be used for various image generation tasks including image super-resolution, generation of images with perceptual metrics, conditional generation (e.g., generation based on text guidance), image inpainting, and image manipulation. Specifically, VAEs are trained to take random noise as input and generate unseen images with features similar to the training data. Video generation in machine learning, another subfield of media processing, refers to the process of using models to automatically create video content from scratch or based on some input such as text, images, or other videos. Video generation models are usually trained to learn patterns in visual data over time (i.e., across frames) and then synthesize realistic-looking videos. These models take into account both spatial (what things look like in a frame) and temporal (how things move/change across frames) features. A synthetic video may be generated based on different inputs (or a combination of different inputs), e.g., text prompts, single images, sequences of images or keyframes, existing videos.

### SUMMARY

The present disclosure describes systems, apparatuses and methods for media processing, more specifically for media generation using machine learning models. In some embodiments, a media processing apparatus receives an input prompt including speech content. The media processing apparatus generates speech articulation features that represents a facial expression (e.g. smiling while speaking, enunciating selected vowels in a particular manner, shape or movement of lips) corresponding to the speech content. The speech articulation features are generated using an audio-to-speech-articulation model (e.g. represented as Audio2SpArt), where the input prompt includes an audio modality. The media processing apparatus generates, using a media generation model (e.g. represented as SpArtN), a synthetic image based on the speech articulation features, for example via an attention network followed by a decoder included in SpArtN. The synthetic image depicts a face with the facial expression vocalizing the speech content. In some cases, the media generation model further includes a pose encoder and an identity encoder, enabling disentanglement of modalities and improving its performance. In some cases, the generated image and/or videos are used for downstream image processing tasks, e.g. further edits, commercial use, or training other media generation models. The methods, apparatuses, and systems have numerous application scenarios, ranging from movie dubbing and personalized advertising to interactive AI avatars.

A method, apparatus, non-transitory computer readable medium, and system for video processing and image generation using machine learning are described. One or more embodiments of the method, apparatus, non-transitory computer readable medium, and system include obtaining an input prompt including speech content; generating, using an audio-to-speech-articulation model, speech articulation features based on the input prompt, wherein the speech articulation features represent a facial expression corresponding to the speech content; and generating, using a media generation model, a synthetic image based on the speech articulation features, wherein the synthetic image depicts a face with the facial expression vocalizing the speech content.

A method, apparatus, non-transitory computer readable medium, and system for video processing and image generation using machine learning are described. One or more embodiments of the method, apparatus, non-transitory computer readable medium, and system include obtaining a training set including audio data and facial expression data; generating predicted speech articulation features based on the audio data; and training, using the facial expression data and the predicted speech articulation features, an audio-to-speech-articulation model to generate speech articulation features corresponding to the audio data.

An apparatus, system, and method for video processing and image generation using machine learning are described. One or more embodiments of the apparatus, system, and method include a memory component; a processing device coupled to the memory component, the processing device configured to perform operations comprising: obtaining an input prompt including speech content; generating, using an audio-to-speech-articulation model, speech articulation features based on the input prompt, wherein the speech articulation features represent a facial expression corresponding to the speech content; and generating, using a media generation model, a synthetic image based on the speech articulation features, wherein the synthetic image depicts a face with the facial expression vocalizing the speech content.

### BRIEF DESCRIPTION OF THE DRAWINGS

FIG. 1 shows an example of a media processing system according to embodiments of the present disclosure.

FIG. 2 shows an example of a method for conditional media generation according to embodiments of the present disclosure.

FIG. 3 shows an example of a method for media processing according to embodiments of the present disclosure.

FIG. 4 shows an example of a media processing apparatus according to embodiments of the present disclosure.

FIG. 5 shows an example of a media generation model according to embodiments of the present disclosure.

FIG. 6 shows an example of an audio-to-speech-articulation model according to embodiments of the present disclosure.

FIG. 7 shows an example of a Visual Stage Neural Network Architecture according to embodiments of the present disclosure.

FIG. 8 shows an example of a variational autoencoder (VAE) architecture according to embodiments of the present disclosure.

FIG. 9 shows an example of a method for training a machine learning model in media processing according to embodiments of the present disclosure.

FIG. 10 shows an example of a method for training an audio-to-speech-articulation model according to embodiments of the present disclosure.

FIG. 11 shows an example of a procedure for training an audio-to-speech-articulation model according to embodiments of the present disclosure.

FIG. 12 shows an example of a method for training a media generation model according to embodiments of the present disclosure.

FIG. 13 shows an example of a procedure for training a media generation model according to embodiments of the present disclosure.

FIG. 14 shows an example of a method for media processing with style prompt according to embodiments of the present disclosure.

FIG. 15 shows an example of a method for media processing with identity and pose references according to embodiments of the present disclosure.

FIG. 16 shows an example of a procedure for data extraction in media processing according to embodiments of the present disclosure.

FIG. 17 shows an example of a procedure for training a machine learning model according to embodiments of the present disclosure.

FIG. 18 shows an example of a computing device for image processing according to embodiments of the present disclosure.

### DETAILED DESCRIPTION

The present disclosure describes systems, apparatuses and methods for media processing, more specifically for media generation using machine learning models. In some embodiments, a media processing apparatus receives an input prompt including speech content. The media processing apparatus generates speech articulation features that represents a facial expression (e.g. smiling while speaking, enunciating selected vowels in a particular manner, shape or movement of lips) corresponding to the speech content. The speech articulation features are generated using an audio-to-speech-articulation model (e.g. represented as Audio2SpArt), where the input prompt includes an audio modality. The media processing apparatus generates, using a media generation model or system (e.g. represented as SpArtN), a synthetic image based on the speech articulation features, for example via an attention network followed by a decoder included in SpArtN. The synthetic image depicts a face with the facial expression vocalizing the speech content. In some cases, the media generation model further includes a pose encoder and an identity encoder, enabling disentanglement of modalities and improving its performance. In some cases, the generated image and/or videos are used for downstream image processing tasks, e.g. further edits, commercial use, or training other media generation models. The methods, apparatuses and systems have numerous application scenarios, ranging from movie dubbing and personalized advertising to interactive AI avatars.

Generative artificial intelligence (AI) has transformed various aspects of multimedia content creation, with advancements in text-to-speech synthesis, image generation, and video manipulation. An intriguing application within computer vision is lip synchronization in spokesperson videos, where the goal is to align visual lip movements with a given audio. The task is challenging in zero-shot and few-shot scenarios, where a machine learning model should be configured to generalize to unseen speakers, languages, or environments.

Lipsync refers “lip synchronization”—a term for matching a speaking person's lip movements with spoken vocals. Conventional methods for lipsync media generation rely on 3D Morphable Model (3DMM) face priors. The face shape in a 3DMM is assumed to be represented using identity and expression parameters. To estimate these parameters, the input video of the person is used to fit the 3D mesh. Some methods involve using pre-trained models to directly predict the face shape. The underlying goal is to disentangle expression and identity features so that a separate model can be trained to predict the expression parameters from audio features. These conventional methods or models generate decent results on frontal constant-lighting videos, but they cannot generalize to unconstrained videos because 3DMMs do not capture inner mouth information (e.g., teeth, tongue, etc.), which is important for generating correct lipsync. The face shape estimation by such conventional methods or models is also inaccurate because faces might have glasses, wrinkles, pimples, etc., which are outliers to the compressed space of 3DMMs.

The present disclosure improves on conventional machine learning models by more efficiently and accurately generating synthetic media (e.g. images or videos) depicting lip synchronization. For example, using an audio-to-speech-articulation model (e.g. “Audio2SpArt”), a media generation model or system (e.g. “SpArtN”) and a data extraction network (e.g. “X-Tractor”), the methods and systems according to present disclosure includes an end-to-end framework for lipsync that processes unconstrained video data and captures the lipsync information explicitly using a compressed space without assuming any face shape prior or any training on the input video, thus applicable for arbitrary “in-the-wild” target faces. The zero-shot nature, combined with its computational efficiency and ability to handle unconstrained videos while maintaining high fidelity, positions the media generation model as a practical and generalizable solution for real-world lip synchronization tasks at a large scale. Further, by including a pose channel and an identity channel, some embodiments of the media generation model (e.g. SpArtN) include a custom variational autoencoder (VAE) based architecture to inpaint a region of interest in an image/frame while jointly learning a compressed space of speech articulation features, which is disentangled from an identity and a pose of a speaker in the image/frame.

In some embodiments, at training, a robust distributed pipeline (e.g. X-tractor) is implemented for processing unconstrained video data at scale, enabling training on diverse real-world data. Architecture and training schemes of the audio-to-speech-articulation model and media generation model are designed such that the sequence-to-sequence framework is lightweight (e.g. comprising reasonable amount of reasonably sized parameters), so that computation efficiency and scalability of the machine learning model are improved over conventional methods or models, with accuracy preserved.

In some embodiments, a media generation model according to the present disclosure is represented as SpArtN (short for Speech Articulation Network), and an audio-to-speech-articulation model according to the present disclosure is represented as Audio2SpArt (short for Audio-to-Speech-Articulation). During inference, the target speech articulation features corresponding to a given target audio are computed using Audio2SpArt conditioned on the speaking style of the input video. The target speech articulation features are then combined with the pose features and identity features of the input video using SpArtN to generate a synthetic image or an output video. SpArtN is a custom autoencoder network that can disentangle speech articulation features from the identity and pose, without relying on explicit 3D face models or shape priors.

In some cases, during inference, Audio2SpArt obtains input prompt including an audio modality; in some embodiments the input prompts further include an image modality (e.g. facial images in sequence) or a video modality. Audio2SpArt obtains a style prompt based on the input prompt (e.g. aligning corresponding facial image with respective audio data), generates an internal style feature/embedding, and generates speech articulation features accordingly for downstream components of SpArtN to consume. SpArtN generates a synthetic image or video accordingly, where the synthetic image depicts lipsync contents consistent with a target style indicated by the style prompt, and the synthetic video includes the synthetic image as a frame. To generate the synthetic image or video, SpArtN uses a conditional image decoder to decode an attention output from a conditional model; in some examples the conditional image decoder takes the speech articulation features as well. The attention output is also based on facial identity features generated by an identity encoder based on identity reference image(s), and facial pose features generated by a pose encoder based on pose reference image(s). More details about inference aspects of SpArtN and Audio2SpArt are described with reference to 4-6 and 14-16.

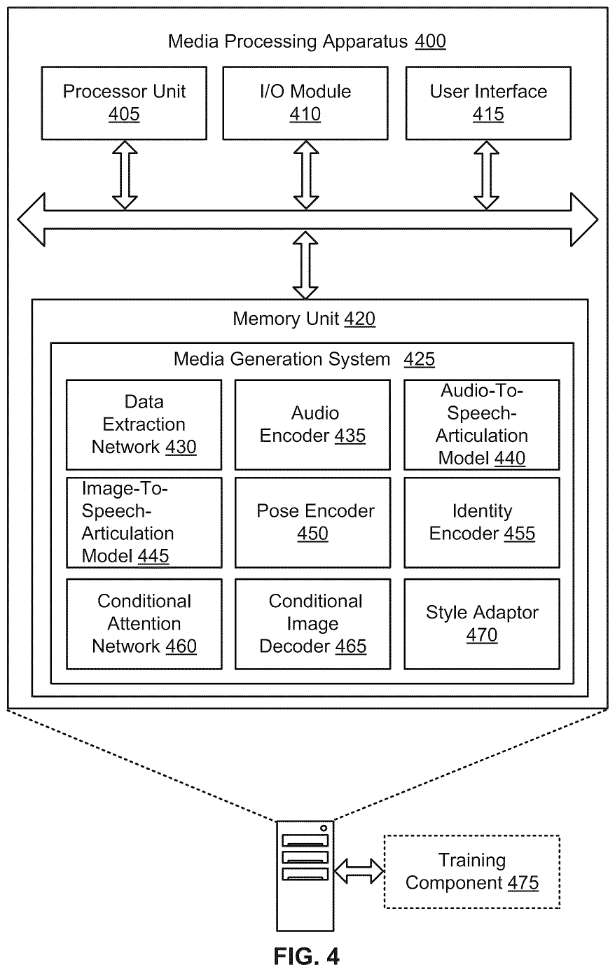

In some embodiments, during training, SpArtN updates parameters based on a loss function including an Kullback-Leibler divergence (KLD) loss that encourages similarity between a first distribution generated/predicted by an audio encoder and a second distribution generated/predicted by an image-to-speech-articulation model (in some embodiments represented as SpArt Encoder, short for Speech-Articulation Encoder). The loss function may further include a Mean Squared Error (MSE) loss, an adversarial loss, and other terms arranged in a weighted combination to encourage similarity between ground truth image (including facial expression data) and the synthetic image. In some cases, Audio2SpArt is trained using an MSE loss encouraging a similarity between facial expression features generated by the image-to-speech-articulation model (SpArt Encoder, or SpArtEnc) and predicted speech articulation features. For both networks (SpArtN and Audio2SpArt), the training is based on audio data and facial expression data, where training data sets for SpArtN and Audio2SpArt may be different. More details about training aspects of SpArtN and Audio2SpArt are described with reference to FIGS. 4, 9-13 and 16.

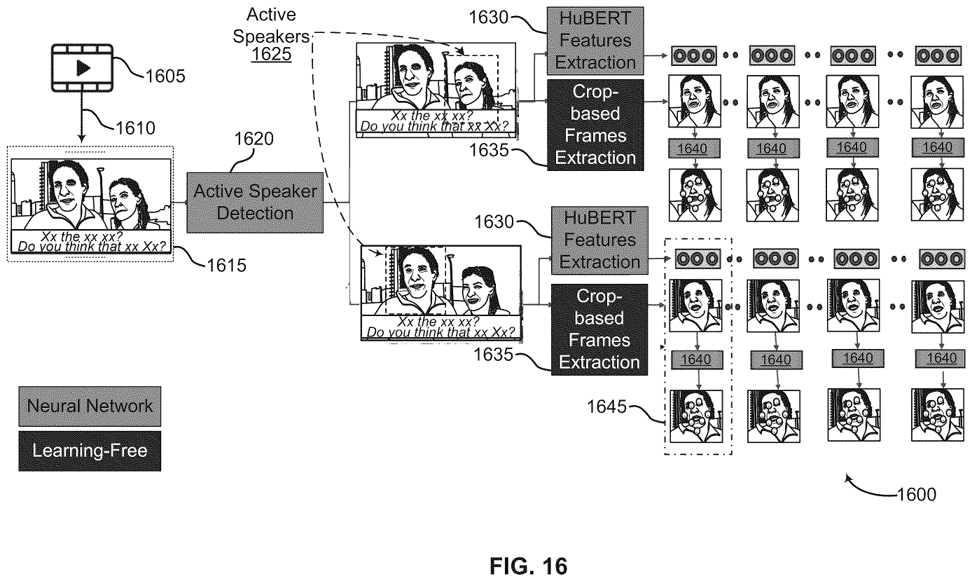

In some embodiments, to prepare input data used in training or inference, a data extraction network according to the present disclosure is used. The data extraction network represented as X-tractor. X-tractor processes unconstrained video data at scale to generate audio data and facial expression data. Particularly, X-tractor segregates scenes/frames, detects active speakers per scene, extracts HuBERT features to generate audio data, and applies key point detection for cropped frames (focusing on active speaker of that frame) to generate facial expression data. More details about data preparation/extraction aspect of the present disclosure are described with reference to FIG. 16.

The term “lip synchronization” or “lipsync” refers to matching a speaking person's lip movements with spoken vocals. The term “speech content” refers to content, subject matter, material, idea or information include in a speech, represented in one or more modalities such as audio, video, or text.

The term “speech articulation” refers to the physical process of producing speech sounds through the coordinated movement of various parts of the vocal tract, such as the lips, tongue, teeth, jaw, and vocal cords. The term “speech articulation features” refers to representation of features or characteristics of speech articulation in an embedding space, for example as a tensor or vector, where the represented features or characteristics includes e.g. a facial expression corresponding to the speech content. The goal of generating the speech articulation features can include capturing the lip, eye, and muscle information in a given face image, so that a media generation model generates a synthetic image based on the speech articulation features includes the lipsync information, e.g. by depicting a face with the facial expression vocalizing the speech content.

The term “audio-to-speech-articulation model” refers to a machine learning model that consumes an input prompt typically including an audio modality and generates the speech articulation features. Some embodiments of the audio-to-speech-articulation model include Audio2SpArt, where the input prompts further include an image modality (e.g. facial images in sequence) or a video modality.

The term “media generation model” or “media generation system” refers to a machine learning model that generates a synthetic media item, e.g. the synthetic image depicting the face with the facial expression vocalizing the speech content. Examples of the media generation model or media generation system includes SpArtN as described herein, referring for example to FIGS. 4-5 and 13.

The term “facial expression features” refers to internal features generated by an image-to-speech-articulation model representing “facial expression” (e.g. smiling, pouting, enunciating different vowels//consonants) typically focusing on sound related areas on or near a face, such as the lips, tongue, teeth, jaw, and vocal cords. The image-to-speech-articulation model is represented as SpArt Encoder in some cases. The term “facial expression data” refers to data including the facial expression that is fed into a media generation or audio-to-speech-articulation pipeline to generate facial expression features or speech articulation features. In some embodiments, facial expression data is of an image modality, e.g. arranged in a sequence, or of a video modality. The term “audio data” refers to data of an audio modality fed into the media generation or audio-to-speech-articulation pipeline for various purposes; for example, at inference, the audio-to-speech-articulation model takes the audio data and a style prompt and generates speech articulation features for use by downstream components of the media generation model; for example, at training, an audio encoder generates a first distribution based on the audio data (included in a training set) for training the image-to-speech-articulation model to generate similar distributions using an KLD loss.

The term “style prompt” refers to an input to a style adaptor included in the audio-to-speech-articulation model, where the style prompt indicates a “target speech style” or target “speaking style,” such as a specific manner/lip shape when pronouncing certain vowels, or certain way of smiling. In some embodiments, the style prompt is formed by aligning facial expression features with corresponding audio data from a compatible frame included in a training video, e.g. where the frames are arranged in a sequence; some embodiments further include random sampling from the aligned sequence pairs. The term “zero-shot” refers to a property for a neural network or “framework” where the neural network or framework requires no training on an input video and is applicable for arbitrary in-the-wild target facial images.

### Media Generation

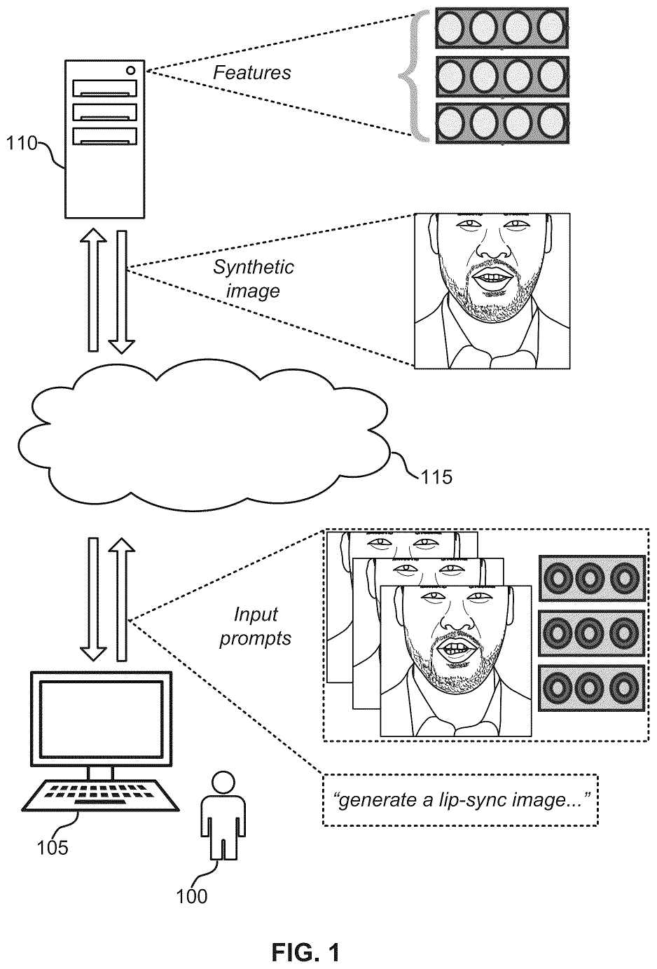

FIG. 1 shows an example of a media processing system according to embodiments of the present disclosure. The example shown includes user 100, user device 105, media processing apparatus 110, and cloud 115. Media processing apparatus 110 is an example of, or includes aspects of, the corresponding element described with reference to FIG. 4.

In FIG. 1, user 100 provides input prompts including image or sequence of images depicting facial expression or an input video including the image or sequence of images as frame(s). The input prompts include speech contents corresponding to the facial expression and further include audio data corresponding to the image or sequence of images. In some embodiments, the user provides a text prompt (e.g. “generate a lip-sync image . . . ”) indicating an instruction or task for media processing apparatus 110. User 100 wants to generate a synthetic image (or synthetic video) depicting a face with the facial expression vocalizing the speech content. The input prompts are transmitted to media processing apparatus 110, for example via user device 105 and through cloud 115.

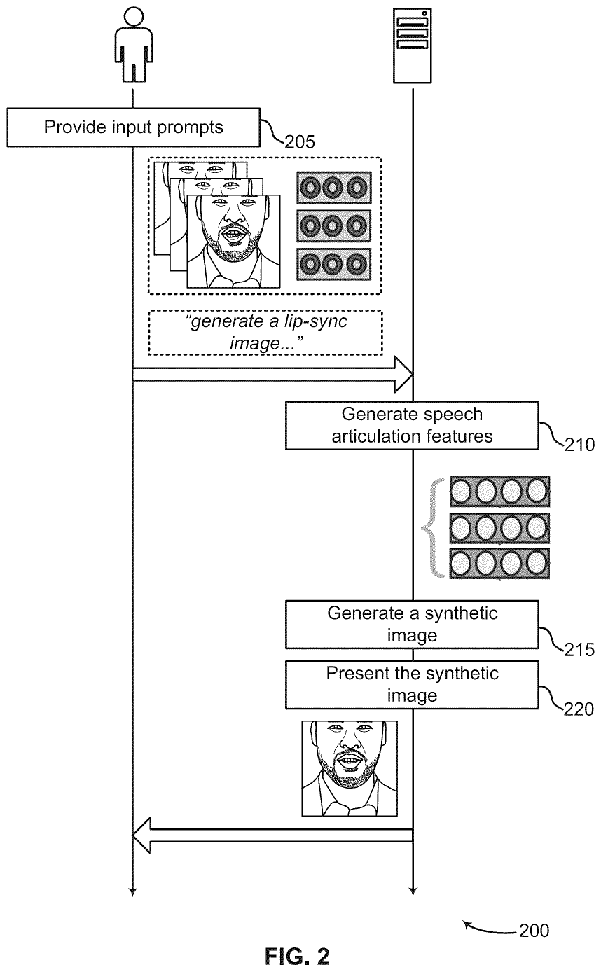

Media processing apparatus 110, based on the input prompts, generates internal features representing the facial expression. In some embodiments the internal features are referred to as speech articulation features. The media processing apparatus 110, based on the internal features, generates the synthetic image depicting the face with the facial expression vocalizing the speech content. Operations generating the speech articulation features and the synthetic image are described in detail with reference to FIGS. 2-6 and 9-16. Media processing apparatus 110 returns the synthetic image to user 100, e.g. via cloud 115 and user device 105.

In some cases, the media processing apparatus 110 generates a synthetic video based on the speech articulation features, the synthetic video or some frames thereof depicting the face with the facial expression vocalizing the speech content, where the synthetic image is, includes aspects of, or corresponds to a frame of the synthetic video; media processing apparatus 110 returns the synthetic video to user 100, e.g. via cloud 115 and user device 105. In some cases, the synthetic image or synthetic video is further transmitted, e.g. via cloud 115, to a database for storage or usage as training data for other machine learning models configured to perform downstream tasks. In some embodiments, the database stores data in a specified format known as a schema, and can be structured as a single database, a distributed database, multiple distributed databases, or a backup database; for instance, the database can be configured to communicate with media processing apparatus 110 with cloud 115, or to receive user interaction from user 100 via user device 105. In some cases, a database controller may manage data storage and processing in the database.

User device 105 may be a personal computer, laptop computer, mainframe computer, palmtop computer, personal assistant, mobile device, or any other suitable generation apparatus. In some examples, user device 105 includes software that incorporates a media processing application (e.g., a media generator, a media editing tool). In some examples, the media processing application on user device 105 may include functions of media processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Media processing apparatus 110 includes a computer-implemented network comprising a media generation model/media generation system. Media processing apparatus 110 may also include a processor unit, a memory unit, an I/O module, and a user interface. In some cases, an architecture of media processing apparatus 110 or some components thereof is also referred to as a network, a machine learning model, or a network model. Further detail regarding the architecture of media processing apparatus 110 is provided with reference to FIGS. 4-8. Further detail regarding the operations of media processing apparatus 110 is provided with reference to FIGS. 2-6 and 9-16.

In some cases, media processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable generation apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

FIG. 2 shows an example of a method 200 for conditional media generation according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 205, the system provides input prompts. In the example shown, the input prompts include audio data and facial expression data (e.g. image/sequence of images or input video including the image/sequence of images as frames) including speech content. Alternatively or additionally, user provides a text prompt, e.g. indicating an instruction to a media processing apparatus. In some cases, the operations of this step may be performed by a user as described with reference to FIG. 1.

At operation 210, the system generates speech articulation features. The speech articulation features represent a facial expression (e.g. slighting opening mouth/smiling) corresponding to the speech content included in the input prompt. In some embodiments, at inference, the speech articulation features are generated using an audio-to-speech-articulation model include in a media processing apparatus. In some cases, the operations of this step may be performed by a media processing apparatus as described with reference to FIGS. 1 and 4.

At operation 215, the system generates a synthetic image. The synthetic image depicts a face with the facial expression vocalizing the speech content. In some cases, the synthetic image is generated based on the speech articulation features. In some cases, the operations of this step may be performed by a media processing apparatus as described with reference to FIGS. 1 and 4.

At operation 220, the system presents a synthetic image. In some cases, the operations of this step may be performed by a media processing apparatus as described with reference to FIGS. 1 and 4.

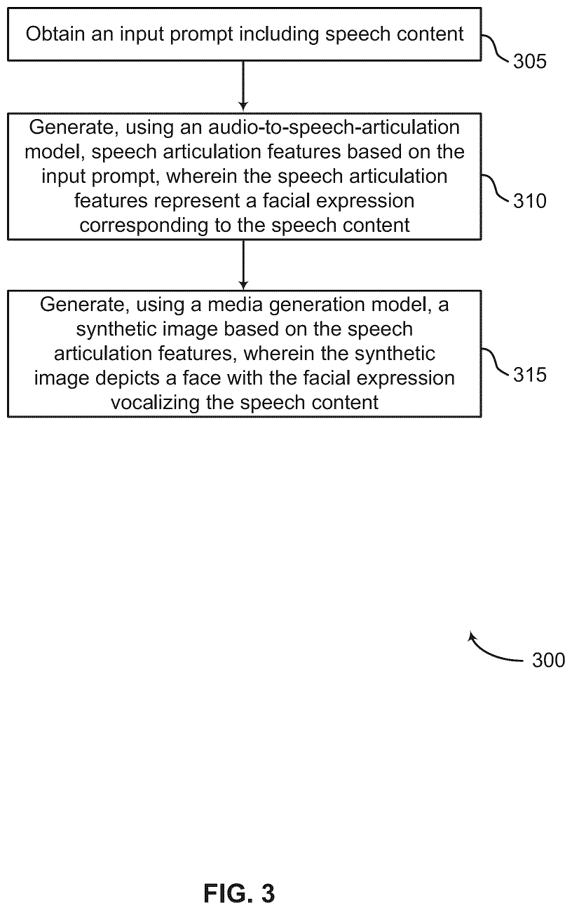

FIG. 3 shows an example of a method 300 for media processing according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 305, the system obtains an input prompt including speech content. Input prompt may include audio data (i.e. in audio modality) and facial expression data (e.g. in image or video modality). The term “speech content” refers to content, subject matter, material, idea or information include in a speech, represented in one or more modalities such as audio, video, or text. In some cases, the operations of this step may be performed by a media generation system as described with reference to FIGS. 4-5 and 13, or an audio-to-speech-articulation model (in some examples included in the media generation system), as described with reference to FIGS. 4-6, and 11.

At operation 310, the system generates, using an audio-to-speech-articulation model, speech articulation features based on the input prompt, where the speech articulation features represent a facial expression corresponding to the speech content. The term “speech articulation” refers to the physical process of producing speech sounds through the coordinated movement of various parts of the vocal tract, such as the lips, tongue, teeth, jaw, and vocal cords. The term “speech articulation features” refer to representation of features or characteristics of speech articulation in an embedding space, for example as a tensor or vector, where the represented features or characteristics includes e.g. a facial expression corresponding to the speech content. In some cases, the operations of this step may be performed by a media generation system as described with reference to FIGS. 4-5 and 13, or an audio-to-speech-articulation model (in some embodiments included as part of the media generation system), as described with reference to FIGS. 4-6, and 11.

At operation 315, the system generates, using a media generation model, a synthetic image based on the speech articulation features, where the synthetic image depicts a face with the facial expression vocalizing the speech content. The term “facial expression” typically focuses on sound related areas on or near a face, such as the lips, tongue, teeth, jaw, and vocal cords; for example, facial expression may comprise smiling, pouting, or enunciating different vowels/consonants. In some cases, the operations of this step may be performed by a media generation model/media generation system as described with reference to FIGS. 4-5, and 13.

In FIGS. 1-3, a method, apparatus, non-transitory computer readable medium, and system for video processing and image generation using machine learning is described. One or more embodiments of the method, apparatus, non-transitory computer readable medium, and system include obtaining an input prompt including speech content; generating, using an audio-to-speech-articulation model, speech articulation features based on the input prompt, wherein the speech articulation features represent a facial expression corresponding to the speech content; and generating, using a media generation model, a synthetic image based on the speech articulation features, wherein the synthetic image depicts a face with the facial expression vocalizing the speech content. In some embodiments, the input prompt comprises an audio modality. In some embodiments, the media generation system comprises, or includes aspects of, the media generation system as described with reference to FIGS. 4-5 and 13.

Some examples of the method, apparatus, non-transitory computer readable medium, and system further include obtaining a text prompt. Some examples further include converting the text prompt to an audio modality.

Some examples of the method, apparatus, non-transitory computer readable medium, and system further include obtaining a style prompt indicating a target speech style, wherein the speech articulation features are based on the style prompt, and wherein the synthetic image depicts the face vocalizing the speech content with the target speech style.

In some examples of the method, apparatus, non-transitory computer readable medium, and system, generating the synthetic image further includes generating a synthetic video based on the speech articulation features, wherein the synthetic image comprises a frame of the synthetic video. In some embodiments, the synthetic video is synchronized with an audio track of the speech content.

In some examples of the method, apparatus, non-transitory computer readable medium, and system, generating the synthetic image further includes decoding the speech articulation features and an attention output from a conditional attention model.

In some embodiments, the media generation model is trained using audio data and facial expression data extracted from a training video. In some embodiments, the media generation model is trained using an image-to-speech-articulation model. In some embodiments, the audio-to-speech-articulation model is trained using an image-to-speech-articulation model.

Some examples of the method, apparatus, non-transitory computer readable medium, and system further include obtaining an identity reference image. Some examples further include generating facial identity features based on the identity reference image, wherein the synthetic image is generated based on the facial identity features.

Some examples of the method, apparatus, non-transitory computer readable medium, and system further include obtaining a pose reference image. Some examples further include generating facial pose features based on the pose reference image, wherein the synthetic image is generated based on the facial pose features.

### Network Architecture

FIG. 4 shows an example of a media processing apparatus 400 according to embodiments of the present disclosure. The example shown includes media processing apparatus 400, processor unit 405, I/O module 410, user interface 415, memory unit 420, media generation system 425, and training component 475.

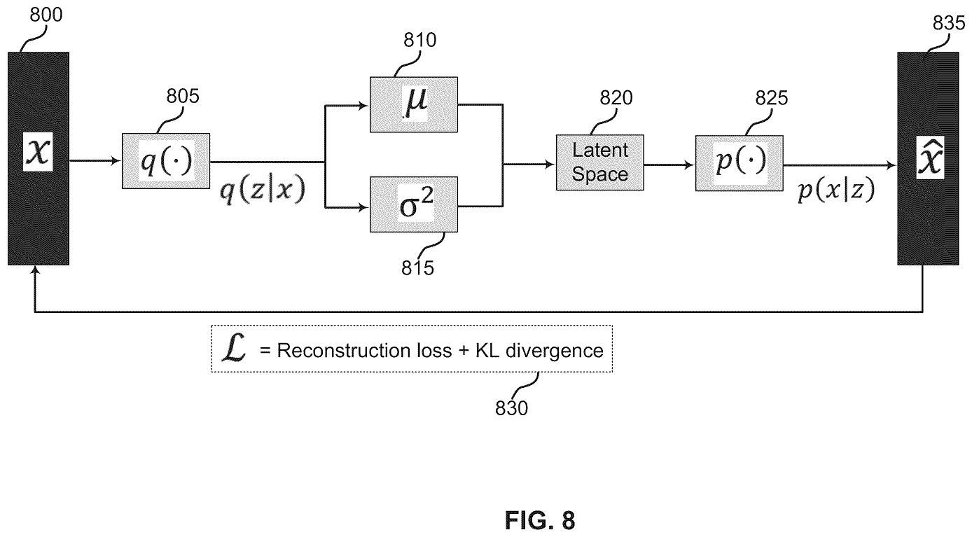

Media processing apparatus 400 is an example of, or includes aspects of, the corresponding element described with reference to FIG. 1. In some embodiments, media processing apparatus 400 includes processor unit 405, I/O module 410, user interface 415, memory unit 420, media generation system 425, and training component 475. In some examples, media processing apparatus 400 or media generation system 425 includes an example of, or aspects of, the VAE described with reference to FIG. 8. In some embodiments, training component 475 is located outside media processing apparatus 400.

Processor unit 405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

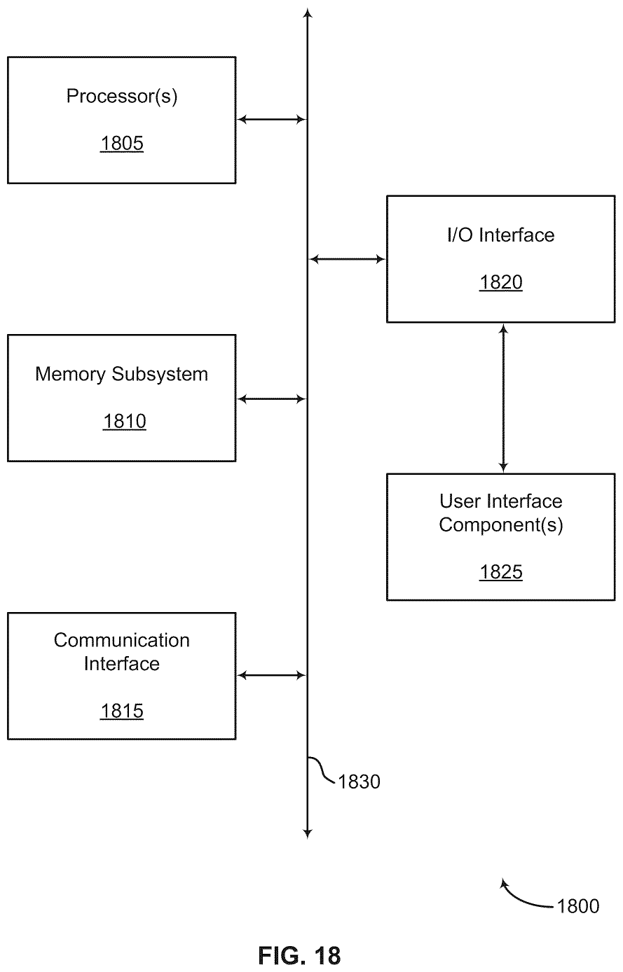

In some cases, processor unit 405 is configured to operate a memory array using a memory controller. In other cases, a memory controller is integrated into processor unit 405. In some cases, processor unit 405 is configured to execute computer-readable instructions stored in memory unit 420 to perform various functions. In some aspects, processor unit 405 includes special purpose components for modem processing, baseband processing, digital signal processing, or transmission processing. According to some embodiments, processor unit 405 comprises one or more processors of a system (e.g. computing device 1800 described with reference to FIG. 18). In some examples, the one or more processors are coupled to a memory component (e.g. memory unit 420), and the one or more processors are configured to perform operations as described with reference to FIGS. 2-3, 5-6 and 9-16.

I/O module 410 receives inputs from and transmits outputs of the media processing apparatus 400 to other devices or users. For example, I/O module 410 receives inputs for the media generation system 425 and transmits outputs of the media generation system 425. According to some aspects, I/O module 410 is an example of the I/O interface 1820 described with reference to FIG. 18.

According to some embodiments, user interface 415 receives an input prompt from a user (e.g. user 100 described in FIG. 1), where the input prompt includes speech content. In some cases, the input prompt includes audio modality. Media generation system 425 obtains the input prompt through user interface 415, in some examples. User interface 415 includes aspects of corresponding elements described with reference to FIG. 18.

Memory unit 420 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 405 to perform various functions described here, for example with reference to FIGS. 2-3, 5-6 and 9-16. According to some embodiments, memory unit 420 comprises the memory component of the system (e.g. computing device 1800 described with reference to FIG. 18).

In some cases, memory unit 420 includes a basic input/output system (BIOS) that controls basic hardware or software operations, such as an interaction with peripheral components or devices. In some cases, memory unit 420 includes a memory controller that operates memory cells of memory unit 420. For example, the memory controller may include a row decoder, column decoder, or both. In some cases, memory cells within memory unit 420 store information in the form of a logical state. According to some aspects, memory unit 420 is an example of the memory subsystem 1810 described with reference to FIG. 18.

According to some embodiments, memory unit 420 stores instructions executable by processors, and media processing apparatus 400 uses one or more processors of processor unit 405 to execute the instructions stored in memory unit 420 to perform functions described here, for example as described with reference to FIGS. 2-3, 5-6 and 9-16. In some cases, the memory unit 420 contains or hosts media generation system 425 configured to perform operations as described with reference to FIGS. 2-3, 5-6 and 9-16; in additional or alternative embodiments, media generation system 425 is located on one or more media processing apparatuses including media processing apparatus 400, where each of the one or more media processing apparatuses may include a memory unit that contains or hosts part or all of media generation system 425.

In some embodiments, media generation system 425 is an artificial neural network (ANN) such as aspects of the VAE described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

Parameters of media generation system 425 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

According to some embodiments, media generation system 425 obtains an input prompt including speech content. In some examples, media generation system 425 generates, using an audio-to-speech-articulation model 440, speech articulation features based on the input prompt, where the speech articulation features represent a facial expression corresponding to the speech content. In some examples, media generation system 425 generates a synthetic image based on the speech articulation features, where the synthetic image depicts a face with the facial expression vocalizing the speech content. In some cases, the input prompt comprises an audio modality.

In some examples, media generation system 425 obtains a text prompt. In some examples, media generation system 425 converts the text prompt to an audio modality. In some examples, media generation system 425 generates a synthetic video based on the speech articulation features, where the synthetic image includes a frame of the synthetic video. In some aspects, the synthetic video is synchronized with an audio track of the speech content. In some aspects, the media generation system 425 is trained using audio data and facial expression data extracted from a training video. In some examples, the media generation system 425 is trained using an image-to-speech-articulation model 445.

According to some embodiments, media generation system 425 obtains a training set including audio data and facial expression data. In some examples, media generation system 425 generates, for example using an audio-to-speech-articulation model 440 included therein, predicted speech articulation features based on the audio data. In some examples, training component 475 trains, using the facial expression data and the predicted speech articulation features, the audio-to-speech-articulation model 440 to generate speech articulation features corresponding to the audio data.

According to some embodiments, media generation system 425 generates a synthetic image based on the speech articulation features, wherein the synthetic image depicts a face with the facial expression vocalizing the speech content. In some aspects, the media generation system 425 includes as backbone a variational autoencoder (VAE), e.g. as described with reference to FIG. 8.

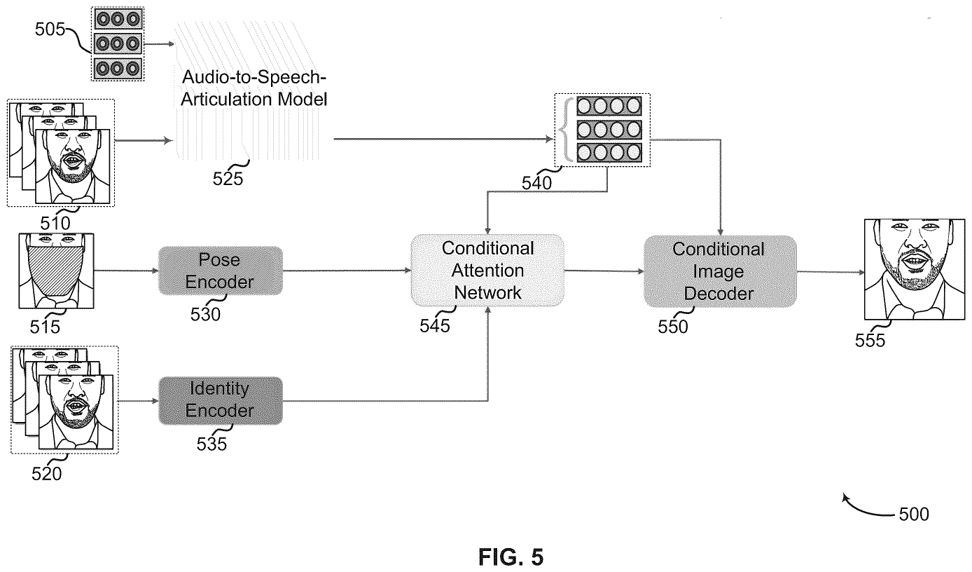

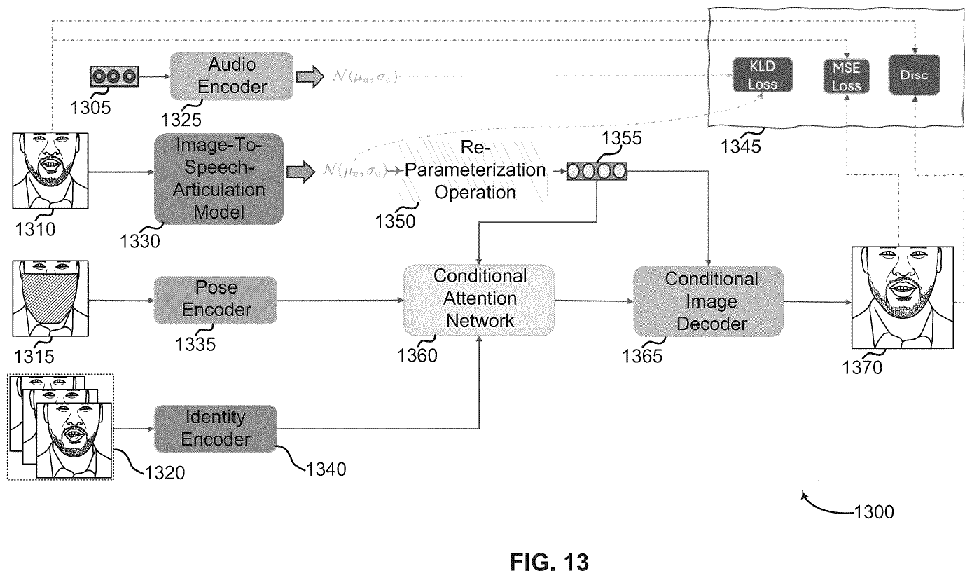

Media generation system 425 is an example of, or includes aspects of, the corresponding element described with reference to FIGS. 5 and 13. In some embodiments, media generation system 425 includes data extraction network 430, audio encoder 435, audio-to-speech-articulation model 440, image-to-speech-articulation model 445, pose encoder 450, identity encoder 455, conditional attention network 460, conditional image decoder 465, and style adaptor 470.

Data extraction network 430 is an example of, or includes aspects of, the corresponding element described referring to FIG. 16. In some embodiments, data extraction network 430 extracts, from a training video, audio data and facial expression data used to train media generation system 425.

Audio encoder 435 is an example of, or includes aspects of, the corresponding element described with reference to FIG. 13. Audio-to-speech-articulation model 440 is an example of, or includes aspects of, the corresponding element described with reference to FIGS. 5-6, and 11.

In some embodiments, audio-to-speech-articulation model 440 obtains the input prompt, where the input prompt includes an audio modality. In some aspects, the audio-to-speech-articulation model 440 is trained using an image-to-speech-articulation model 445. According to some embodiments, audio-to-speech-articulation model 440 generates predicted speech articulation features based on the audio data.

According to some embodiments, audio-to-speech-articulation model 440 obtains an input prompt including speech content. In some examples, audio-to-speech-articulation model 440 generates speech articulation features based on the input prompt, where the speech articulation features represent a facial expression corresponding to the speech content. In some examples, the audio-to-speech-articulation model 440 includes a one-dimensional (1D) conditional convolution model.

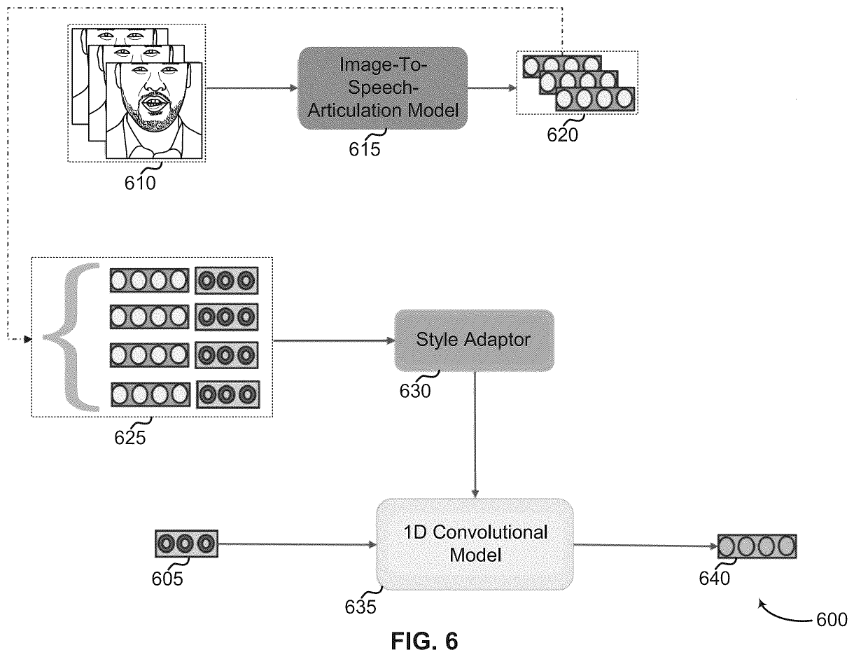

According to some embodiments, image-to-speech-articulation model 445 generates facial expression features based on the facial expression data. Image-to-speech-articulation model 445 is an example of, or includes aspects of, the corresponding element described with reference to FIGS. 6, 11, and 13.

According to some embodiments, pose encoder 450 obtains a pose reference image. In some examples, pose encoder 450 generates, or is configured to generate, facial pose features based on the pose reference image, where the synthetic image is generated based on the facial pose features. Pose encoder 450 is an example of, or includes aspects of, the corresponding element described with reference to FIGS. 5 and 13.

According to some embodiments, identity encoder 455 obtains an identity reference image. In some examples, identity encoder 455 generates, or is configured to generate, facial identity features based on the identity reference image, where the synthetic image is generated based on the facial identity features. Identity encoder 455 is an example of, or includes aspects of, the corresponding element described with reference to FIGS. 5 and 13.

Conditional attention network 460 is an example of, or includes aspects of, the corresponding element described with reference to FIGS. 5 and 13. For example, conditional attention network 460 obtains speech articulation features 540 (referring to FIG. 5), a pose embedding generated from pose encoder 450, and an identity embedding generated from identity encoder 455, then generates an attention output fed to conditional image decoder 465.

According to some embodiments, conditional image decoder 465 decodes the speech articulation features and an attention output from a conditional attention model, e.g. conditional attention network 460. Conditional image decoder 465 is an example of, or includes aspects of, the corresponding element described with reference to FIGS. 5 and 13.

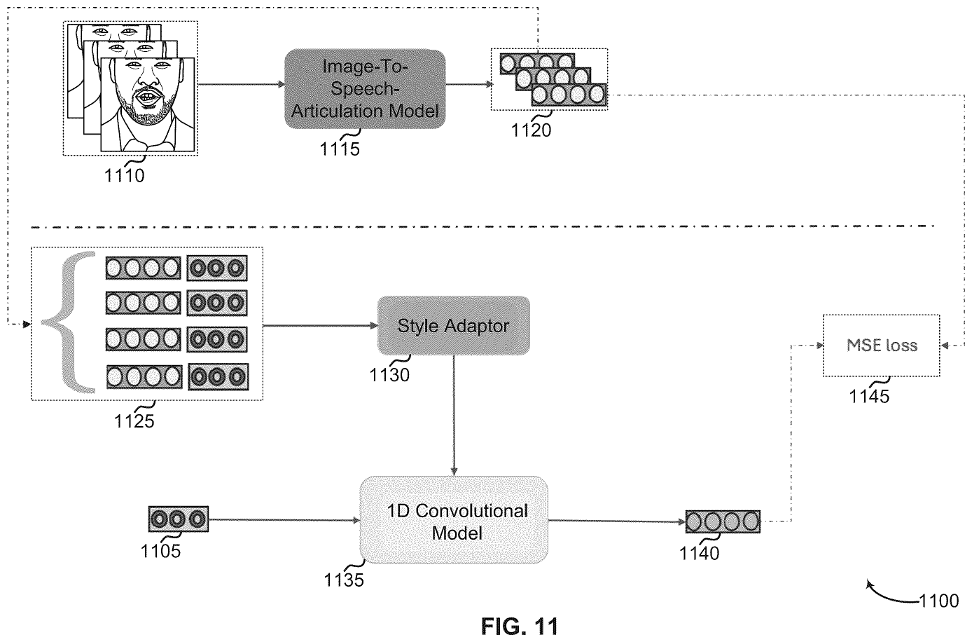

According to some embodiments, style adaptor 470 obtains a style prompt indicating a target speech style, where the speech articulation features are based on the style prompt, and where the synthetic image depicts the face vocalizing the speech content with the target speech style. In some embodiments, style adaptor 470 is included in audio-to-speech-articulation model 440. Style adaptor 470 is an example of, or includes aspects of, the corresponding element described with reference to FIGS. 6 and 11.

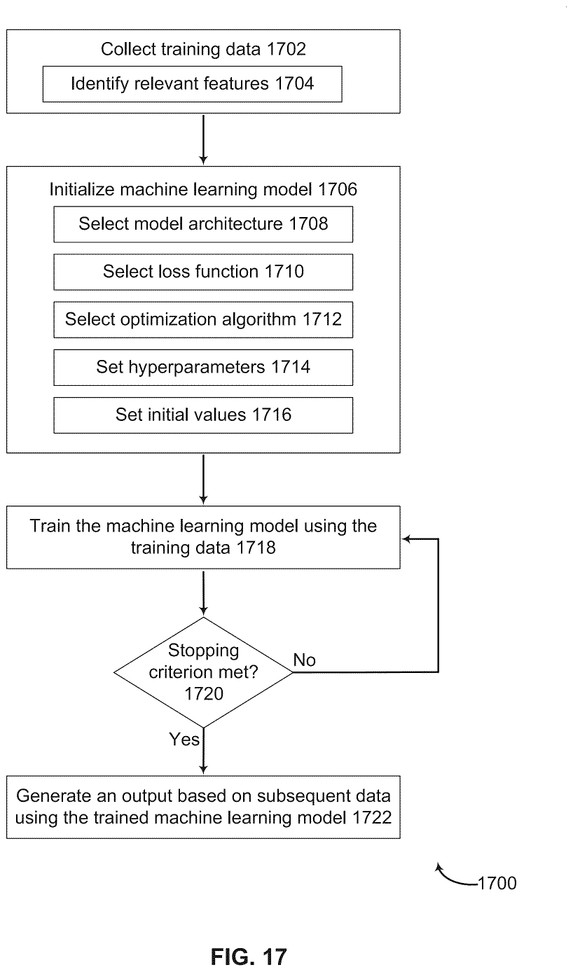

In some embodiments, training component 475 is configured to train or fine-tune the media generation system 425. For example, the parameters of the media generation system 425 can be learned or estimated from training data and then used to make predictions or perform tasks based on learned patterns and relationships in the data. In some examples, the parameters are adjusted during the training process to minimize a loss function or maximize a performance metric (e.g., processes as described with reference to FIG. 17). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, media generation system 425 can be used to make predictions on new, unseen data (i.e., during inference). In some cases, training component 475 is located outside media processing apparatus 400. In some cases, the machine learning parameters are stored in memory unit 420 or a database.

According to some embodiments, training component 475 trains, using the facial expression data and the predicted speech articulation features, an audio-to-speech-articulation model 440 to generate speech articulation features corresponding to the audio data. In some examples, training component 475 computes a loss function by comparing the predicted speech articulation features to the facial expression features. In some examples, training component 475 updates parameters of the audio-to-speech-articulation model 440 based on the loss function. In some examples, training component 475 trains a media generation system 425 to generate a synthetic image based on speech articulation features.

FIG. 5 shows an example of a media generation system 500 according to embodiments of the present disclosure. The example shown includes media generation system 500, audio data 505, facial expression data 510, pose reference image 515, identity reference image 520, audio-to-speech-articulation model 525, pose encoder 530, identity encoder 535, speech articulation features 540, conditional attention network 545, conditional image decoder 550, and synthetic image 555.

In FIG. 5, media generation system 500 is at inference. Media generation system 500 obtains an input prompt including audio data 505 and facial expression data 510. The input prompt includes speech content. Audio-to-speech-articulation model 525 takes the input prompt including audio data 505 and facial expression data 510 and generates speech articulation features 540. The speech articulation features 540 represents a facial expression corresponding to the speech content. In some embodiments, media generation system 500 obtains pose reference image 515 via pose encoder 530 and obtains identity reference image 520 via identity encoder 535, respectively generating a pose output/embedding and an identity output/embedding.

The speech articulation features 540, the pose output/embedding, and the identity output/embedding go into conditional attention network 545, generating an attention output that is taken by conditional image decoder 550; in some embodiments, conditional image decoder 550 further takes the speech articulation features 540. The conditional image decoder 550 decodes the speech articulation features 540 and the attention output, generating synthetic image 555. Synthetic image 555 depicts a face with the facial expression vocalizing the speech content. In some alternative or additional embodiments, media generation system 500 generates a synthetic video based on the speech articulation features 540, where the synthetic image 555 comprises a frame of the synthetic video; in some cases, the synthetic video is synchronized with an audio track of the speech content.

Media generation system 500 is an example of, or includes aspects of, the corresponding element described with reference to FIGS. 4 and 13. In some embodiments, media generation system 500 is alternatively or additionally referred to as a Speech Articulation Network (“SpArtN”) architecture or SpArtN model. Some embodiments of the media generation system 500 include a feedforward neural network, enabling faster inference speeds.

Audio data 505 is an example of, or includes aspects of, the corresponding element described with reference to FIGS. 6, 11, and 13. In some embodiments, audio data 505 is obtained by converting a text prompt to an audio modality. In some embodiments, input prompt including audio data 505 includes speech content. In some cases, at inference the audio data 505 can be generated from data extraction network 1600 as described with reference to FIG. 16 for example based on unconstrained video 1605.

Facial expression data 510 is an example of, or includes aspects of, the corresponding element described with reference to FIGS. 6, 11, and 13. In some embodiments, at inference, facial expression data 510 refers to one or more images depicting a face, for example arranged in a sequence corresponding to an input video. At inference, facial expression data 510 is fed to audio-to-speech-articulation model 525 to generate speech articulation features 540 for downstream processing in media generation system 500.

Pose reference image 515 is an example of, or includes aspects of, the corresponding element described with reference to FIG. 13. Identity reference image 520 is an example of, or includes aspects of, the corresponding element described with reference to FIG. 13. In some embodiments, identity reference image 520 includes a set of reference images.

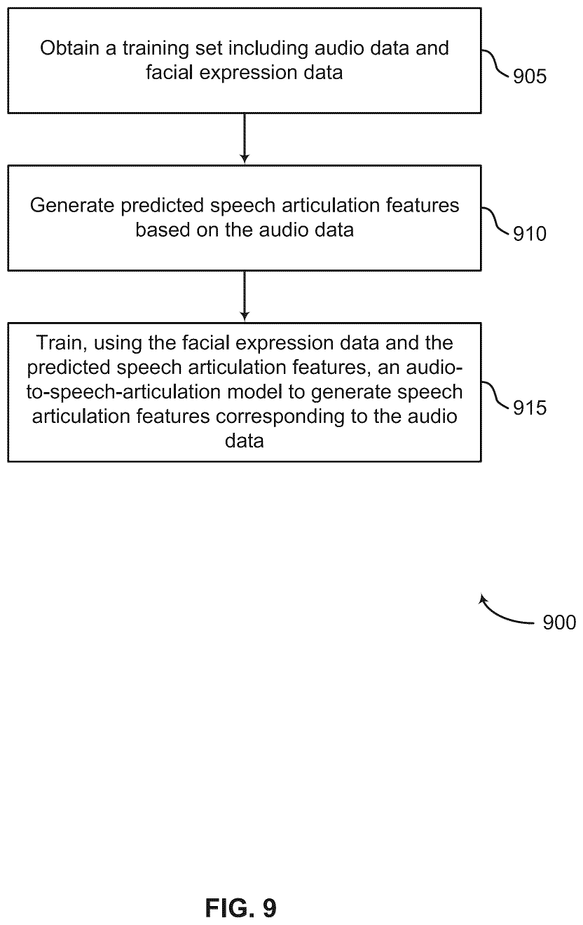

Audio-to-speech-articulation model 525 is an example of, or includes aspects of, the corresponding element described with reference to FIGS. 4, 6, and 11. In some embodiments, audio-to-speech-articulation model 525 is an example of audio-to-speech-articulation model 600 as described with reference to FIG. 6, and at inference, audio-to-speech-articulation model 525 or audio-to-speech-articulation model 600 operates to generate speech articulation features 540 for downstream processing. Training aspects of audio-to-speech-articulation model 525 or audio-to-speech-articulation model 600 are described with reference to FIGS. 9-13.

Pose encoder 530 is an example of, or includes aspects of, the corresponding element described with reference to FIGS. 4 and 13. Pose encoder 530 (PoseEnc) takes a masked image M, which is constructed by masking out the region of interest in the ground truth image I_{gt} to extract [symbol] , information like pose, lighting, background, etc. from facial expression data 510 other than expression or identity. Unlike conventional methods, which use a simple 2D mask that covers the jaw, the media generation system uses the 3D landmarks of the face to construct a 3D mask that covers the jaw and neck region of the face; in some examples, 3D landmarks refer to or include aspects of key points detected by key point detection 1640 referring to FIG. 16. This ensures that our masking logic is robust to extreme head poses. The media generation system overlays the face mask onto the input images, coloring it according to the (x, y, z) coordinates of points on the 3D surface. This provides additional depth information to the network, which made the training converge faster. Operation of pose encoder 530 to extract P is represented as follows:

[symbol]

=PoseEnc(3DMask(I_{gt})) (1)

Identity encoder 535 is an example of, or includes aspects of, the corresponding element described with reference to FIGS. 4 and 13. Identity encoder 535 (IdEnc) takes a set of reference images R (Identity reference image 520) from an input video to extract identity information a. Multiple reference images are utilized to enable the network to capture subtle nuances in facial structure, such as inner-mouth details and facial deformations including dimples and wrinkles. In some embodiments, a number of reference images in the set (Identity reference image 520) is randomly selected between 4 and 8 during each training step to ensure that the network learns to use as many images as possible. At inference time, the media generation system can reduce the reference image count, e.g., 1 to 4, to increase speed and improve efficiency of image generation based on quality requirement provided by user(s). Operation of identity encoder 535 to extract the identity information a is represented as:

α=IdEnc(R) (2)

Using pose encoder 530, identity encoder 535, and an image-to-speech-articulation model (e.g. image-to-speech-articulation model 615 described with reference to FIG. 6) that is included in audio-to-speech-articulation model 525, media generation system 500 is a custom autoencoder architecture that can disentangle speech articulation features from the identity and pose. Pose encoder 530, Identity encoder 535, and the image-to-speech-articulation model are respectively constrained to extract distinct modalities with disentangled features. Specifically, any face image I, such as synthetic image 555, can be represented using the following formulation:

I= [symbol] (α,δ, [symbol] ) (3)
where α, δ and [symbol] represent the identity, the expression, and other information like pose, lighting, background, etc. respectively. For α and [symbol] , see also description of identity encoder 535 and pose encoder 530 above respectively, where identity encoder 535 extracts the identity modality (α) and pose encoder 530 extracts the pose related modality ( [symbol] ). [symbol] is the media generation system 500 (e.g. SpArtN model) that combines information from all the modalities to create the image I.

By including a pose channel and an identity channel, some embodiments of media generation system 500 include a custom variational autoencoder (VAE) based architecture to inpaint a region of interest in an image/frame while jointly learning a compressed space of speech articulation features, which is disentangled from the identity and pose of a speaker in the image/frame. Additionally, 3D masking methods, for example as applied to the pose channel of the image generation model, ensure robustness to extreme head poses and varying lighting conditions.

Speech articulation features 540 is an example of, or includes aspects of, the corresponding element described with reference to FIGS. 6 and 13. In some embodiments, at inference, speech articulation features 540 refers to or includes aspects of speech articulation features 640, generated by operations of audio-to-speech-articulation model 525 or audio-to-speech-articulation model 600. Speech articulation features 540 represent a facial expression corresponding to the speech content included in the input prompt (e.g. including audio data 505 and/or facial expression data 510).

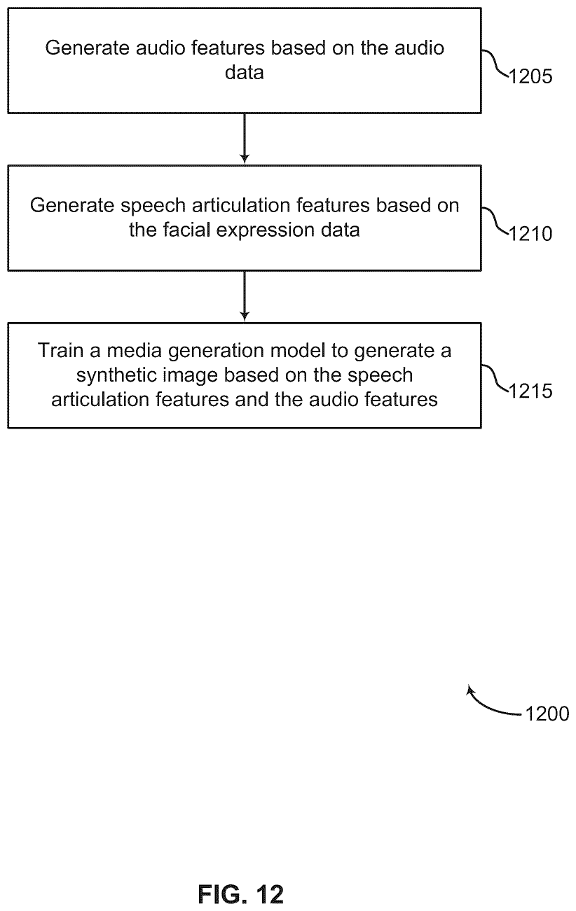

Conditional attention network 545 is an example of, or includes aspects of, the corresponding element described with reference to FIGS. 4 and 13. In some embodiments, at inference, conditional attention network 545 takes speech articulation features 540, an output of pose encoder 530, and an output of identity encoder 535, then generates an attention output fed to conditional image decoder 550. Training aspects of conditional attention network 545 are described in more detail (e.g. loss terms) with reference to FIGS. 12-13.

Conditional image decoder 550 is an example of, or includes aspects of, the corresponding element described with reference to FIGS. 4 and 13. Conditional image decoder 550 takes the attention output from conditional attention network 545, and in some embodiments also takes the speech articulation features 540. In some embodiments, conditional image decoder 550 decodes the speech articulation features 540 and the attention output to generate the synthetic image 555. Training aspects of conditional image decoder 550 are described in more detail (e.g. loss terms) with reference to FIGS. 12-13.

Synthetic image 555 is an example of, or includes aspects of, the corresponding element described with reference to FIG. 13. In some embodiments, synthetic image 555 generated by media generation system 500 depicts a face with the facial expression vocalizing the speech content.

In some embodiments, the model replaces speech articulation encodings of a video using a different set of values, and the media generation system 500 is configured to generate a synthetic video based on speech articulation features (e.g. speech articulation features 540), where the synthetic image 555 comprises a frame of the synthetic video; in some embodiments, the synthetic video is synchronized with an audio track of the speech content, and the synthetic video includes different lipsync while preserving head pose and identity.

Compared to conventional methods such as 3DMM-based techniques, media generation system 500 improves machine learning/AI models by effectively modeling inner-mouth details and subtle facial variations. media generation system 500 maintains high fidelity even under extreme head poses and varying lighting conditions. Additionally, some embodiments of media generation system 500 advance beyond single-reference techniques, accurately capturing identity and speaking style information using multiple references from an input video, improving quality and accuracy/faithfulness in lipsync media generation.

FIG. 6 shows an example of an audio-to-speech-articulation model 600 according to embodiments of the present disclosure. The example shown includes audio-to-speech-articulation model 600, audio data 605, facial expression data 610, image-to-speech-articulation model 615, facial expression features 620, style prompt 625, style adaptor 630, 1D convolutional model 635, and speech articulation features 640.

FIG. 6 illustrates audio-to-speech-articulation model 600 at inference. Audio-to-speech-articulation model 600 obtains facial expression data 610 and audio data 605 (e.g. included in the input prompt as described with reference to FIG. 5). Image-to-speech-articulation model 615 takes facial expression data 610 and generates facial expression features 620. Audio-to-speech-articulation model 600 obtains or generates style prompt 625 based on facial expression features 620 and audio data 605 (e.g. by respectively aligning facial expression features 620 and corresponding audio data 605 for a compatible frame or scene). The style prompt 625 indicates a target speech style. Style adaptor 630 takes the style prompt 625 and generates a style embedding representing the target style that is fed, together with audio data 605, into 1D convolutional model 635.

Based on audio data 605 and the style embedding, 1D convolutional model 635 generates speech articulation features 640, e.g. as speech articulation features 540 for downstream processing in FIG. 5. In some embodiments, synthetic image 555, being generated based on speech articulation features 640 as described herein, depicts the face vocalizing the speech content with the target speech style as indicated by the style prompt 625.

Audio-to-speech-articulation model 600 is an example of, or includes aspects of, the corresponding element described with reference to FIGS. 4-5 and 11. For example, at inference, speech articulation features 640 as output of audio-to-speech-articulation model 600 is fed to media generation system 500 as speech articulation features 540. Training aspects of audio-to-speech-articulation model 600 are described with reference to FIGS. 9-11.

Audio data 605 is an example of, or includes aspects of, the corresponding element described with reference to FIGS. 5, 11, and 13. Facial expression data 610 is an example of, or includes aspects of, the corresponding element described with reference to FIGS. 5, 11, and 13. In some embodiments, facial expression data 610 is an input video, or one or more sequences of frames thereof. In some examples, an input prompt obtained by audio-to-speech-articulation model 600 includes audio data 605 and facial expression data 610.

Image-to-speech-articulation model 615 is an example of, or includes aspects of, the corresponding element described with reference to FIGS. 4, 11, and 13. In some embodiments, image-to-speech-articulation model 615 is referred to as speech articulation encoder (SpArtEnc). Facial expression features 620, generated by image-to-speech-articulation model 615, is an example of, or includes aspects of, the corresponding element described with reference to FIG. 11. Training aspects of image-to-speech-articulation model 615 (SpArtEnc) are described with reference to FIG. 13.

Style prompt 625 is an example of, or includes aspects of, the corresponding element described with reference to FIG. 11. Style adaptor 630 is an example of, or includes aspects of, the corresponding element described with reference to FIGS. 4 and 11. In some embodiments, the speech articulation features 640 are based on the style prompt 625, for example based on a style embedding generated by style adaptor 630 from the style prompt 625. Related training aspects are described with reference to FIG. 11. In some embodiments, style adaptor 630 is included so that audio-to-speech-articulation model 525 generates speech articulation features 64 from an audio input while preserving a target speaking style, enabling more natural and personalized lipsync results.

1D convolutional model 635 is an example of, or includes aspects of, the corresponding element described with reference to FIG. 11. For example, training aspects of 1D convolutional model 635 is described with reference to FIG. 11. Speech articulation features 640 is an example of, or includes aspects of, the corresponding element described with reference to FIGS. 5 and 13.

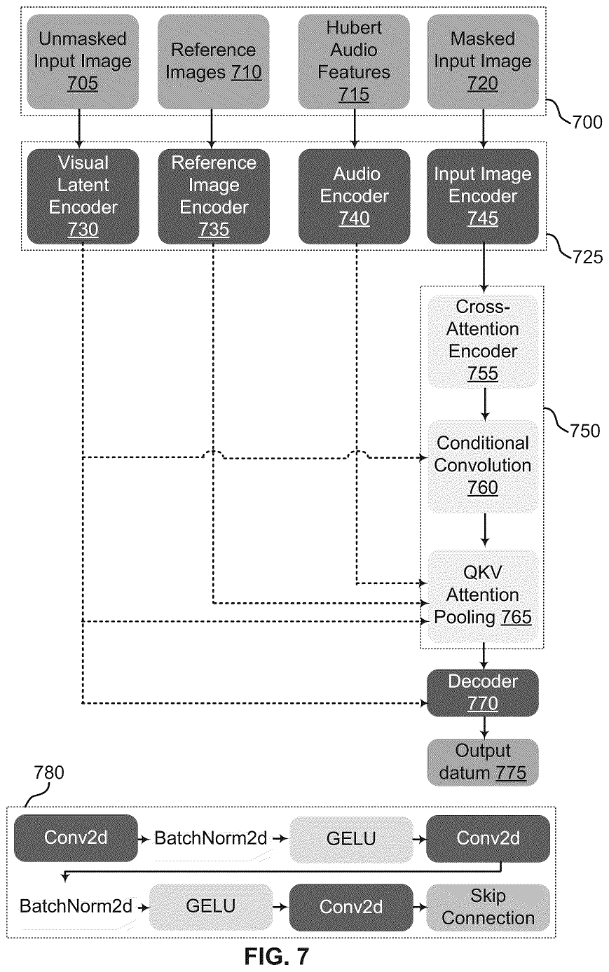

FIG. 7 shows an example of a Visual Stage Neural Network Architecture according to embodiments of the present disclosure. The example shown includes input datum 700, set of encoders 725, attention 750, decoder 770, output datum 775, and MbConv Block 780 (short for Mobile Inverted Bottleneck Convolutional Block). As such, the Visual Stage Neural Network Architecture is generally an “Encoder-Attention-Decoder” pipeline. In some embodiments, the Visual Stage Neural Network Architecture is an example of, or includes aspects of, the media generation system 500 as described with reference to FIG. 5.

In some embodiments, input datum 700 includes unmasked input image 705, reference images 710, Hubert audio features 715 (or HuBERT audio features), and masked input image 720; set of encoders 725 includes visual latent encoder 730, reference image encoder 735, audio encoder 740, and input image encoder 745; attention 750 includes cross-attention encoder 755, conditional convolution 760, and QKV attention pooling 765; decoder 770 is an image decoder; output datum 775 is an RGB image that is generated at inference (and e.g. a reconstructed RGB image at training); and MbConv Block 780 is included as a layer in e.g. visual latent encoder 730, conditional convolution 760, and some other components for downsample, residual, or initial refinement, as described in detail below.

In some embodiments, unmasked input image 705 is represented as a tensor of dimensionality [batch, 3, 512, 512], where batch stands e.g. for a total number of batches. Unmasked input image 705 (e.g. for each batch) is or represents an RGM image (second axis is 3) with full resolution (e.g. 512*512), with complete visual context. Unmasked input image 705 is fed to visual latent encoder 730.

In some embodiments, reference images 710 is an example of or includes aspects of corresponding elements described with reference to FIGS. 5 and 13. In some examples, reference images 710 is represented as a tensor of dimensionality [batch, r, 3, 512, 512], where r≥1 is a total number of the reference images; in some cases, r is in a range between 4 and 8, inclusive of both ends. Reference images 710 includes multiple RGB images, provides reference to poses and context for style or identity. Reference images 710 is fed to reference image encoder 735.

In some embodiments, Hubert audio features 715 is an example of or includes aspects of corresponding elements described with reference to FIGS. 5, 13 and 16. In some examples, Hubert audio features 715 has a dimensionality of [batch, 31, 768]. Hubert audio features 715 includes aspects of pre-trained features used to enable audio-visual synchronization in the image generation process and provides speech context. Hubert audio features 715 is fed to audio encoder 740.

In some embodiments, masked input image 720 is represented as a tensor of dimensionality [batch, 4, 512, 512], where the second axis includes RGB and a mask channel. Masked input image 720 provides partial visual information and, in some embodiments, provides a target for inpainting. Masked input image 720 is fed to input image encoder 745.

In some embodiments, visual latent encoder 730 returns an output of dimensionality [batch, 64], fed to conditional convolution 760 (as such, the conditioning is visual latent guided), QKV attention pooling 765, and decoder 770. In some examples, visual latent encoder 730 includes a Conv2d (3→8,6*6, s=2), where s may generally stand for “stride,” the second parameter of the format ks*ks may generally stand for kernel size, and x→y may generally stand for “number of input channels→number of output channels” via the block. In some examples, visual latent encoder 730 further includes an MbConv (8→16) followed by an MbConv (16→96). The MbConv layers are examples of or include aspects of MbConv Block 780 described below. In some embodiments, visual latent encoder 730 further includes as layers Reshape (4096, 96), AddPositionalEncoding, Transformer (32 h×256d), 4×MbConv layers for downsampling, Linear (1536→64), and a BatchNorm1d+GELU (Gaussian Error Linear Unit activation).

In some embodiments, reference image encoder 735 returns an output of dimensionality [batch×r, 3, 512, 512], fed to QKV attention pooling 765. In some embodiments, reference image encoder 735 includes a Conv2d (3→16,6*6, s=2), followed by MbConv Residual (16→16), MbConv Downsample (16→32), MbConv Residual (32→32), MbConv Downsample (32→64), MbConv Residual (64→64), MbConv Downsample (64→96), MbConv Residual (96→96), and Tanh activation. Reference image encoder 735 includes aspects of corresponding elements described with reference to FIGS. 5 and 13.

In some embodiments, audio encoder 740 returns an output of dimensionality [batch, 31, 768], fed to QKV attention pooling 765. In some embodiments, audio encoder 740 has input parameter dimensionality 31×768 (e.g. for each batch), and includes Linear (31→60), ReLU, Linear (60→5), Reshape (768×5), Linear (3840→256), BatchNorm1d, GELU+Dropout, and Linear (256→64) as layers. Audio encoder 740 includes aspects of corresponding elements described with reference to FIGS. 5 and 13.

In some embodiments, input image encoder 745 returns an output of dimensionality [batch, 4, 512, 512], fed to cross-attention encoder 755. In some embodiments, input image encoder 745 includes Conv2d (4→16,6×6, s=2), MbConv Residual (16→16), MbConv Downsample (16→32), MbConv Residual (32→32), MbConv Downsample (32→64), MbConv Residual (64→64), MbConv Downsample (64→96), MbConv Residual (96→96), and Tanh Activation as layers. Input image encoder 745 includes aspects of corresponding elements described with reference to FIGS. 5 and 13.

In some embodiments, cross-attention encoder 755 returns an output of dimensionality [batch, r, 4096, 192], fed to conditional convolution 760. In some embodiments, cross-attention encoder 755 includes Reshape (spatial=>sequence), AddPositionalEncoding, Linear Q/K/V Projections, Multillead Attention (32 h), Linear Output Projection, LayerNorm, Feed-Forward (192→768→192), GELU Activation, and Residual Connections. Cross-attention encoder 755 includes aspects of corresponding elements described with reference to FIGS. 5 and 13.

In some embodiments, conditional convolution 760 returns an output of dimensionality [batch×r, 192, 64, 64], fed to QKV attention pooling 765. In some embodiments, conditional convolution 760 includes MbConv (expand=2, ks=3, dilation=2), where “expand” may stand for expansion ration indicating how much to increase the input channels before depth convolution, ks may stand for kernel size (e.g. of a square kernel having as width and height both ks), and dilation may stand for a dilation rate indicating a spacing between kernel elements to increase a receptive field without increasing the kernel size. In some embodiments, conditional convolution 760 further includes BatchNorm2d, GELU Activation, Depthwise Conv (3×3), Pointwise Conv (1×1), MbConv (expand=2, k=3, dilation=2), Skip Connections, Visual Latent Conditioning (conditioning in some embodiments is visual latent guided) and Tanh Activation. Conditional convolution 760 includes aspects of corresponding elements described with reference to FIGS. 5 and 13.

In some embodiments, QKV attention pooling 765 returns an output of dimensionality [batch, 96, 64, 64], fed to decoder 770. In some embodiments, QKV attention pooling 765 includes Linear QKV Projection (192→576), Visual Latent FC (64→192), Query Modulation (Q×latent), MultiHead Attention (8 h), Reference Pooling, Linear Projection (192→96), AddPositionalEncoding, Self-Attention (16 h×96d) and Spatial Reshape as layers. QKV attention pooling 765 includes aspects of corresponding elements described with reference to FIGS. 5 and 13.

In some embodiments, decoder 770 returns an output of dimensionality [batch, 3, 512, 512] as the output datum 775. In some embodiments, decoder 770 includes MbConv Initial Refinement, ConvTranspose2d (96→64, 2×), MbConv Feature Processing, ConvTranspose2d (64→32, 2×), MbConv Feature Processing, ConvTranspose2d (32→16, 2×), GroupNorm (32 groups), Swish (x*sigmoid (x)), Conv2d RGB Output (16→3 e.g. changing the second axis), and Tanh Final Activation. Decoder 770 includes aspects of corresponding elements described with reference to FIGS. 5 and 13.

In some embodiments, output datum 775 has dimensionality [batch, 3, 512, 512], and includes generated (e.g. at inference) or reconstructed (e.g. at training) RGB images, e.g. of height and width 512. They have high-quality output as complete/generated (e.g. at inference)/reconstructed (e.g. at training) output of the pipeline. Training aspects of the pipeline are described with reference e.g. to FIGS. 9-13. In some cases, MbConv Block 780 includes Conv2d 1×1 Expand, BatchNorm2d, GELU, Conv2d 3×3 DW (Depthwise), BatchNorm2d, GELU, Conv2d 1×1 Project (Projection), and Skip Connection.

FIG. 8 shows an example of a variational autoencoder (VAE) architecture according to embodiments of the present disclosure. The example shown includes input datum 800, encoder network 805, mean 810, variance 815, latent space 820, decoder network 825, loss function 830, and output datum 835.

As shown in FIG. 8, the VAE consists of an encoder network 805 (estimating a distribution q_{φ}(z|x)) that maps an input datum 800 (x), such as an image, to parameters of a probability distribution q_{φ}(z|x) over latent variables z. Parameters φ denote trainable parameters of the encoder network 805, and encoder network 805 is denoted in FIG. 8 as q(⋅) in place of q_{φ}(⋅) for simplicity. In various examples, the encoder outputs parameters for a Gaussian distribution with mean 810 (μ) and variance 815 (σ²), thus defining an approximate posterior q(z|x)= [symbol] (μ, diag(σ²)) (in some cases or per some conventions denoted alternatively as [symbol] (μ, σ)).

The latent variable z in latent space 820 is sampled from this Gaussian distribution using a reparameterization trick, such as described with reference to FIG. 13, whereby z=μ+σ⊙ϵ, where e.g. ϵ~ [symbol] (0, I) and ⊙ denotes Hadamard/element-wise multiplication. This reparameterization enables backpropagation through the stochastic sampling operation by separating the deterministic parameters (μ, σ) from the random noise source (ϵ). The sampled latent variables z is provided to decoder network 825 that estimates the conditional distribution p_{θ}(x|z)). Accordingly, the VAE architecture reconstructs the input datum 800 (x) in whole or in part during training, producing the output datum 835 (\hat{x}), or generates novel data as output datum 835 (\hat{x}) by sampling z from the prior distribution during inference. Parameters θ denote trainable parameters of the decoder network 825, and decoder network 825 is denoted in FIG. 8 as p(⋅) in place of p_{θ}(⋅) for simplicity; similarly, p_{θ}(x|z) is denoted as p(x|z) for simplicity.

The training objective maximizes an Evidence Lower Bound (ELBO), which is equivalently expressed as minimizing a negative ELBO loss (loss function 830): [symbol] =− [symbol] _{q}_{_{φ}}_{(Z|X)}[log p_{θ}(x|z)]+D_{KL}[q_{φ}(z|x)∥p(z)].

In some examples of loss function 830, a first term represents a reconstruction loss, measuring the expected negative log-likelihood of the data given the latent variables, and a second term is the Kullback-Leibler (KL) divergence between the approximate posterior q_{φ}(z|x) and the prior distribution p(z); in various cases, the prior distribution p(z) is typically chosen as a standard Gaussian [symbol] (0,I). This KL divergence term acts as a regularizer, encouraging the learned latent distribution to remain close to the prior, thereby ensuring a continuous and well-structured latent space (latent space 820) and facilitating smooth interpolation between data points and enhancing the quality of generative outputs. Loss function 830 includes aspects or examples of the corresponding element as described with reference to FIG. 13.

During training, both the encoder and decoder networks are typically jointly optimized using gradient-based methods to minimize this combined loss (e.g. loss function 830). The balance between reconstruction quality and latent space regularization facilitates smooth interpolation between data points and enables generation of novel samples. During inference, new samples (output datum 835 (\hat{x})) can be generated, e.g., by sampling latent vector z directly from the prior p(z)= [symbol] (0, I) in latent space 820 and passing the sampled z through the decoder network 825. The new samples are generated at inference based on the conditional distribution p_{θ}(x|z).

The encoder and decoder networks in FIG. 8 can be implemented using various neural network architectures depending on the data modality. For image data, convolutional neural networks (CNNs) are commonly employed, with the encoder network 805 in some embodiments using convolutional layers with strided convolutions to progressively reduce spatial dimensions, while in other embodiments using pooling operations. The decoder network 825 may employ transposed convolutions (also called deconvolutions) or upsampling followed by convolutions to restore the original image dimensions. For sequential data such as text or time series, recurrent neural networks (RNNs) or long short-term memory networks (LSTMs) may be utilized. The encoder's final layer typically consists of two parallel fully-connected layers that output the mean and log-variance parameters respectively, where log-variance is often used instead of variance directly for numerical stability.

The architecture shown in FIG. 8 in some embodiments incorporates normalization layers such as batch normalization or layer normalization between network layers to stabilize training, and activation functions such as ReLU, LeakyReLU, or ELU in intermediate layers. The decoder's output activation function typically depends on the data type—e.g. sigmoid activation for binary data, tanh for normalized data, or no activation for continuous unbounded data. Dropout layers may be included for regularization during training. Dimensionality of the latent space 820 is a key hyperparameter that balances representation capacity with regularization strength, typically ranging from 2 dimensions for visualization purposes to hundreds of dimensions for complex datasets.

Applications of the disclosed architecture may include, but are not limited to, representation learning and data generation scenarios such as image synthesis, anomaly detection, data compression, and semi-supervised learning. While FIG. 8 illustrates a particular embodiment with Gaussian latent distributions, other distributional models and regularization schemes are within the scope of this disclosure.

In FIGS. 4-8, an apparatus, system, and method for video processing and image generation using machine learning is described. One or more embodiments of the apparatus, system, and method include a memory component; a processing device coupled to the memory component, the processing device configured to perform operations comprising: obtaining an input prompt including speech content; generating, using an audio-to-speech-articulation model, speech articulation features based on the input prompt, wherein the speech articulation features represent a facial expression corresponding to the speech content; and generating, using a media generation model, a synthetic image based on the speech articulation features, wherein the synthetic image depicts a face with the facial expression vocalizing the speech content. In some embodiments, the media generation model comprises, or includes aspects of, the media generation system described with reference to FIGS. 4-5 and 13.

In some embodiments, the audio-to-speech-articulation model comprises a one-dimensional (1D) conditional convolution model. In some embodiments, the media generation model comprises a variational autoencoder (VAE).

Some examples of the apparatus, system, and method further include an identity encoder configured to generate facial identity features based on an identity reference image, wherein the synthetic image is generated based on the facial identity features.

Some examples of the apparatus, system, and method further include a pose encoder configured to generate facial pose features based on a pose reference image, wherein the synthetic image is generated based on the facial pose features.

### Zero-Shot Style-Preserving Lip Synchronization

FIG. 9 shows an example of a method 900 for training a machine learning model in media processing according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains a training set including audio data and facial expression data. In some cases, the operations of this step may be performed by a media generation system as described with reference to FIGS. 4-5, and 13, or an audio-to-speech-articulation model (in some embodiments included in the media generation system), as described with reference to FIGS. 4-6, and 11. In some embodiments, the training set or some training data included thereof is an example of data 1645 extracted by data extraction network 1600 as described with reference to FIGS. 4 and 16.

At operation 910, the system generates predicted speech articulation features based on the audio data. In some cases, the operations of this step may be performed by an audio-to-speech-articulation model as described with reference to FIGS. 4-6, and 11. For example, audio-to-speech-articulation model 1100 generates predicted speech articulation features 1140 based on audio data 1105.

At operation 915, the system trains, using the facial expression data and the predicted speech articulation features, an audio-to-speech-articulation model to generate speech articulation features corresponding to the audio data. In some cases, the operations of this step may be performed by a training component as described with reference to FIG. 4, and the operations at this step may include aspects of operations by audio-to-speech-articulation model 1100 described referring to FIG. 11.

In some examples, the training is based on loss function 1145, e.g. an MSE loss. In some embodiments, the audio-to-speech-articulation model (e.g. audio-to-speech-articulation model 1100, in some embodiments represented as Audio2SpArt network) is trained only on 1 node with similar optimization settings for 10 minutes because it is a lightweight module. As such, efficiency of speech articulation feature extraction and media generation is improved.

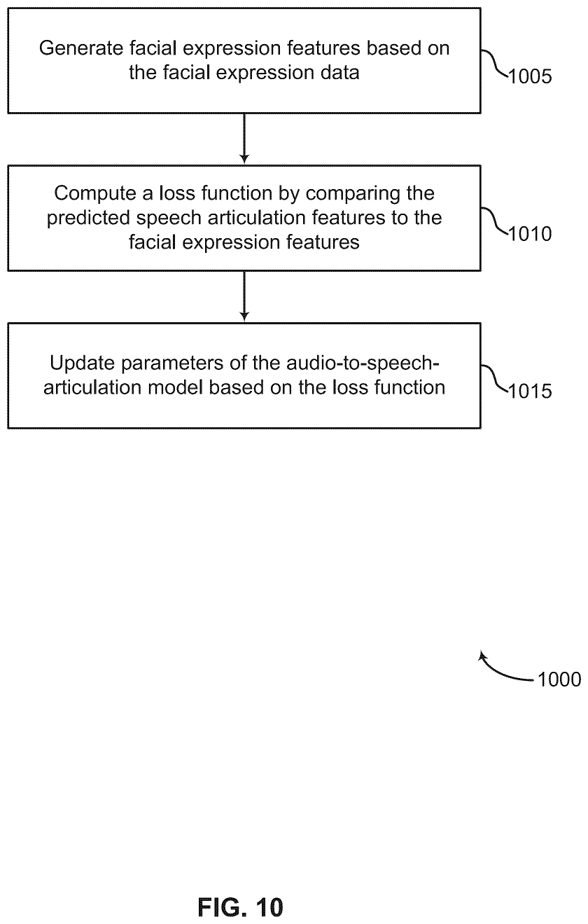

FIG. 10 shows an example of a method 1000 for training an audio-to-speech-articulation model according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system generates facial expression features based on the facial expression data. In some cases, the operations of this step may be performed by an image-to-speech-articulation model as described with reference to FIGS. 4, 6, 11, and 13. For example, image-to-speech-articulation model 1115 generates facial expression features 1120 based on facial expression data 1110.

At operation 1010, the system computes a loss function by comparing the predicted speech articulation features to the facial expression features. In some cases, the operations of this step may be performed by a training component as described with reference to FIG. 4. The loss function refers to or includes aspects of loss function 1145 described with reference to FIG. 11.

At operation 1015, the system updates parameters of the audio-to-speech-articulation model based on the loss function. In some cases, the operations of this step may be performed by a training component as described with reference to FIG. 4. In some examples, the operations of this step may include aspects of corresponding elements as described with reference to FIG. 17.

FIG. 11 shows an example of a procedure for training an audio-to-speech-articulation model 1100 according to embodiments of the present disclosure. The example shown includes audio-to-speech-articulation model 1100, audio data 1105, facial expression data 1110, image-to-speech-articulation model 1115, facial expression features 1120, style prompt 1125, style adaptor 1130, 1D convolutional model 1135, predicted speech articulation features 1140, and loss function 1145.

In FIG. 11, audio-to-speech-articulation model 1100 is at training. Audio-to-speech-articulation model 1100 obtains facial expression data 1110 (e.g. via image-to-speech-articulation model 1115) and audio data 1105. Image-to-speech-articulation model 1115 generates facial expression features 1120. Audio-to-speech-articulation model 1100 obtains or generates style prompt 1125 based on facial expression features 1120 and audio data 1105 (e.g. by respectively aligning facial expression features 1120 and corresponding audio data 1105 for a compatible frame or scene). The style prompt 1125 indicates a target speech style. Style adaptor 1130 takes the style prompt 1125 and generates a style embedding/output representing the target style. 1D convolutional model 1135 takes the style embedding/output and the audio data 1105 and generates predicted speech articulation features 1140 based thereupon.

In some embodiments, a training component of a media processing apparatus (e.g. described with reference to FIG. 4) computes a loss function, e.g. loss function 1145, by comparing the predicted speech articulation features 1140 and the facial expression features 1120. The training component then updates parameters of audio-to-speech-articulation model 1100 based on the loss function, e.g. loss function 1145, thereby training the audio-to-speech-articulation model 1100 to generate speech articulation features corresponding to the audio data 1105. In some embodiments, the training component further trains a media generation model to generate a synthetic image based on speech articulation features, where the media generation model includes the audio-to-speech-articulation model 1100; more details about training the media generation model/system is described with reference to FIGS. 12-13.

Audio-to-speech-articulation model 1100 is an example of, or includes aspects of, the corresponding element described with reference to FIGS. 4-6. For example, inference aspects of audio-to-speech-articulation model 1100 are described with reference to FIG. 6. In some embodiments, audio-to-speech-articulation model 1100 is trained to generate predicted speech articulation features 1140 from a given target speech. e.g. speech content included in training data from a training set, while also preserving speaking style from the input video (e.g. sequence of images included in facial expression data 1110).

Audio data 1105 is an example of, or includes aspects of, the corresponding element described with reference to FIGS. 5-6, and 13. Facial expression data 1110 is an example of, or includes aspects of, the corresponding element described with reference to FIGS. 5-6, and 13. Facial expression data 1110 and audio data 1105 are typically included in a training set. For example, in some embodiments, facial expression data 1110 refers to or include aspects of frames from videos included in training data, and audio data 1105 include the corresponding element described with reference to FIG. 16.

Image-to-speech-articulation model 1115 is an example of, or includes aspects of, the corresponding element described with reference to FIGS. 4, 6, and 13. At training stage of audio-to-speech-articulation model 1100, typically image-to-speech-articulation model 1115 has been trained. Audio-to-speech-articulation model 1100 is trained using image-to-speech-articulation model 1115. Facial expression features 1120 generated by image-to-speech-articulation model 1115 (e.g. SpArtEnc) is an example of, or includes aspects of, the corresponding element described with reference to FIG. 6.

Style prompt 1125 is an example of, or includes aspects of, the corresponding element described with reference to FIG. 6. In some embodiments, Style prompt 1125 is formed by respectively aligning facial expression features 1120 and corresponding audio data 1105 for a compatible frame or scene; in some cases, the facial expression features 1120 are selected randomly from the training data.

Particularly, for a sequence [δ] (e.g. facial expression features 1120 arranged in a sequence), the model obtains a corresponding sequence of audio features [ [symbol] _{gt}] (e.g. audio data 1105 arranged in a sequence corresponding to [δ]). This paired sequence data ([ [symbol] _{gt}], [δ]) is used, e.g. to afford style prompt 1125, to train audio-to-speech-articulation model 1100 or its active components. As image-to-speech-articulation model 1115 (SpArtEnc) is a single image encoding module, referring e.g. to corresponding element of FIG. 13, facial expression features 1120 can be extracted quickly on an entire video dataset.

To obtain style prompt 1125 from the paired sequence data ([ [symbol] _{gt}], [δ]), the model randomly samples small corresponding subsequences of fixed size from the full paired sequence data. These reference sample mappings are then passed into style adaptor 1130 which tries to learn a representation of the speaking style of the spokesperson. Style adaptor 1130 generates/predicts a style embedding accordingly. Style adaptor 1130 is an example of, or includes aspects of, the corresponding element described with reference to FIGS. 4 and 6.

1D convolutional model 1135 is an example of, or includes aspects of, the corresponding element described with reference to FIG. 6. In some embodiments, 1D convolutional model 1135 obtains the style embedding generated by style adaptor 1130, along with a longer corresponding subsequence pair selected from the paired sequence data ([ [symbol] _{gt}], [δ]) and its audio component. 1D convolutional model 1135 reconstructs a speech articulation component, for example by generating predicted speech articulation features 1140 or intermediate versions thereof.

Loss function 1145 is an example of, or includes aspects of, the corresponding element described with reference to FIG. 13. In some embodiments, the loss function 1145 includes aspects of or examples of an MSE loss computed based on facial expression features 1120 and predicted speech articulation features 1140 to improve an accuracy of the prediction. Space of predicted speech articulation features 1140 is regularized using a reparameterization trick, for example re-parameterization operation 1350 as described with reference to FIG. 13. This means that speech articulation features can be smoothly interpolated along the time dimension to match the audio feature sampling rate regardless of the input video frame-per-second (fps). This also means that MSE Loss can be directly used herein without using a separate adversarial loss. Since the audio-to-speech-articulation model 1100 is lightweight and operates in a sequence-to-sequence manner, we can train it on a large variety of datasets which can include different languages and emotions. The speaking style conditioning branch, e.g. via style adaptor 1130, contributes to a significant increase in reconstruction accuracy and lipsync quality. This also proves the effectiveness and the importance of preserving speaking style during lipsync generation.

FIG. 12 shows an example of a method 1200 for training a media generation model/system according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system generates audio features based on the audio data. In some cases, the operations of this step may be performed by an audio encoder as described with reference to FIGS. 4 and 13. For example, Audio encoder 1325 generates/predicts a first distribution ( [symbol] (μₐ, σₐ)) that includes aspects of or examples of audio features.

At operation 1210, the system generates speech articulation features based on the facial expression data. In some cases, the operations of this step may be performed by an audio-to-speech-articulation model as described with reference to FIGS. 4-6, and 11. For example, audio-to-speech-articulation model 1100 generates predicted speech articulation features 1140 based on the facial expression data 1110.

At operation 1215, the system trains a media generation model to generate a synthetic image based on the speech articulation features and the audio features. In some cases, the operations of this step may be performed by a training component as described with reference to FIG. 4. For example, referring to FIGS. 4 and 13, training component 475 trains media generation system 1300 based on speech articulation features 1355 and facial expression data 1310.

In some embodiments, the media generation model (e.g. media generation system 1300 or SpArtN as described with reference to FIG. 13) is trained on a cluster of 4 nodes for 12 hours, each node consisting of 8 A100 GPUs. Adam with OneCycleLR schedule is used for optimization. After the full training of SpArtN is finished, the SpArtN network is fine-tuned further by removing the re-parameterization step (e.g. re-parameterization operation 1350) and KLD Loss (e.g. a term in loss function 1345). Since the re-parameterization step pushes the network toward a slightly different lip shape, the reconstruction losses (e.g. a term in loss function 1345) would force the network to learn an average blurry output. This fine-tuning step improves the overall sharpness of the output, especially for beard textures.

FIG. 13 shows an example of a procedure for training a media generation system 1300 according to embodiments of the present disclosure. The example shown includes media generation system 1300, audio data 1305, facial expression data 1310, pose reference image 1315, identity reference image 1320, audio encoder 1325, image-to-speech-articulation model 1330, pose encoder 1335, identity encoder 1340, loss function 1345, re-parameterization operation 1350, speech articulation features 1355, conditional attention network 1360, conditional image decoder 1365, and synthetic image 1370.

In FIG. 13, media generation system 1300 is at training. Audio encoder 1325 of the media generation system 1300 obtains audio data 1305 (e.g. ground-truth audio features [symbol] _{gt}), and image-to-speech-articulation model 1330 of the media generation system 1300 obtains facial expression data 1310 (e.g. a ground truth image I_{gt}, where ground-truth audio features [symbol] _{gt} correspond to I_{gt}). Audio encoder 1325 generates/predicts a first distribution ( [symbol] (μₐ,σₐ)) based on audio data 1305, and image-to-speech-articulation model 1330 computes/generates a second distribution [symbol] (μᵢ,σᵢ), which is represented via re-parameterization operation 1350 into speech articulation features 1355, in some cases denoted as δ. In some embodiments, pose encoder 1335 of media generation system 1300 obtains pose reference image 1315 and generates a pose output/pose embedding accordingly; and identity encoder 1340 of media generation system 1300 obtains identity reference image 1320 and generates an identity output/identity embedding accordingly.

Speech articulation features 1355, the pose output/pose embedding and the identity output/identity embedding are fed to conditional attention network 1360, generating an attention output. Conditional image decoder 1365 takes the attention output, and in some embodiments the speech articulation features 1355, generating synthetic image 1370. A training component such as the corresponding element described in FIG. 4 trains media generation system 1300 using loss function 1345.

Media generation system 1300 is an example of, or includes aspects of, the corresponding element described with reference to FIGS. 4-5. For example, inference aspects of media generation system 1300 are described with reference to FIGS. 4-5 and 14-15.

Audio data 1305 is an example of, or includes aspects of, the corresponding element described with reference to FIGS. 5-6, and 11; in some embodiments, audio data 1305 includes ground-truth audio features [symbol] _{gt}. Facial expression data 1310 is an example of, or includes aspects of, the corresponding element described with reference to FIGS. 5-6, and 11; in some embodiments, facial expression data 1310 includes a ground truth image I_{gt}, where ground-truth audio features [symbol] _{gt} correspond to I_{gt}. Facial expression data 1310 and audio data 1305 are typically included in a training set. In some embodiments, some data of the training set is obtained by operation of a data extraction network described with reference to FIGS. 4 and 16.

Pose reference image 1315 is an example of, or includes aspects of, the corresponding element described with reference to FIG. 5. Identity reference image 1320 is an example of, or includes aspects of, the corresponding element described with reference to FIG. 5. Pose encoder 1335 is an example of, or includes aspects of, the corresponding element described with reference to FIGS. 4 and 5. Identity encoder 1340 is an example of, or includes aspects of, the corresponding element described with reference to FIGS. 4 and 5. Operations by pose encoder 1335 to generate features or embeddings representing pose reference image 1315, and respectively operations by identity encoder 1340 to generate features or embeddings representing identity reference image 1320, are described in detail with reference to FIG. 5.

Audio encoder 1325 is an example of, or includes aspects of, the corresponding element described with reference to FIG. 4. In some embodiments, audio encoder 1325 generates/predicts a first distribution ( [symbol] (μₐ,σₐ)) based on audio data 1305 (e.g. ground-truth audio features [symbol] _{gt} correspond to I_{gt}), with mean μₐ and variance σₐ. Such operations are represented as:

(μₐ,σₐ)=AudioEnc( [symbol] _{gt}) (4)

Image-to-speech-articulation model 1330 is an example of, or includes aspects of, the corresponding element described with reference to FIGS. 4, 6, and 11. In some embodiments, image-to-speech-articulation model 1330 is also referred to as speech articulation encoder (SpArtEnc). Image-to-speech-articulation model 1330 takes the ground truth image I_{gt} as input and extracts a second distribution [symbol] (μᵢ,σᵢ), based on which downstream operations extracts speech articulation features 1355. Operations of the image-to-speech-articulation model 1330 or SpArtEnc are represented as:

(μᵢ,σᵢ)=SpArtEnc(I_{gt}). (5)

Re-parameterization operation 1350 obtains speech articulation features 1355 (δ) based on the second distribution. Speech articulation features 1355 (δ) is an example of, or includes aspects of, the corresponding element described with reference to FIGS. 5-6. In some embodiments, δ no longer represents an expression vector as the model is configured to avoid capturing excessive information related to eye and eyebrow movements from the top half of the face. Similar to Variational Autoencoders (VAEs), instead of directly representing δ as a vector in a compressed space, the media generation system 1300 represents it as a multivariate normal distribution with mean μᵢ and variance σᵢ and use re-parameterization operation 1350 to get δ. Re-parameterization operation 1350 is represented as:

δ=μᵢ+σᵢ*ϵ (6)
where ϵ is randomly sampled from the standard normal distribution. In some embodiments, “*” may denote entry-wise multiplication. In some embodiments, where [symbol] (μᵢ,σᵢ) is a multivariate normal distribution, its variance refers to or includes aspects of covariance between pairs of variables; for example, μᵢ∈ [symbol] ^{k} with k a number of random variables, the covariance Σᵢ∈ [symbol] ^{k×k}, and re-parameterization operation 1350 is alternatively or additionally performed by δ=μᵢ+Aᵢ*ϵ, where Aᵢ(Aᵢ)^{T}=Σᵢ is Cholesky decomposition or Cholesky factorization of Σᵢ.

Loss function 1345 is an example of, or includes aspects of, the corresponding element described with reference to FIG. 11. Loss function 1345 includes a KLD loss term based on the first distribution (N(μₐ,σₐ)) and the second distribution N(μᵢ,σᵢ), an MSE loss term based on the facial expression data 1310 and generating synthetic image 1370, and a “Disc” term based on the facial expression data 1310 and generating synthetic image 1370; in some cases, the “Disc” term included in loss function 1345 as depicted in FIG. 13 may refer to adversarial loss Adv Loss, where the model jointly trains a typical image discriminator D to distinguish between I and I_{gt}, where/refers to or includes aspects of synthetic image 1370 or intermediate version(s) thereof generated during training, and I_{gt} refers to or includes aspects of facial expression data 1310.

Specifically, Unlike VAEs, which try to bring the encoding distribution N(μᵢ,σᵢ) close to the standard normal distribution, the media generation system 1300 tries to bring the encoding distribution close to N(μₐ,σₐ). This is done using the KLD loss between the two normal distributions, which can be simplified to a closed form as follows:

$$KLDLoss = \frac{( {σ}_{i}^{2} + {( {μ}_{i} - {μ}_{a} )}^{2} )}{( 2 * {σ}_{a}^{2} )} + log ( {σ}_{a} / {σ}_{i} ) - 0.5 \qquad ( 7 )$$

Since the Audio encoder cannot predict identity and pose information just from audio speech features, the KLD Loss constrains the Speech articulation encoder to extract only speech articulation features from lat. In some embodiments, for multivariate normal distributions [symbol] (μᵢ,σᵢ) and [symbol] (μₐ,σₐ) where corresponding variances refer respectively to corresponding covariances, the covariances are represented respectively as matrices Σᵢ and Σₐ∈ [symbol] ^{k×k}, and KLD loss (or Kullback-Leibler divergence loss) is computed, alternatively or additionally, as

$$\frac{1}{2} ( log \frac{det {\sum }_{a}}{det {\sum }_{i}} - k + tr ( {\sum }_{a}^{- 1} {\sum }_{i} ) + {( {μ}_{a} - {μ}_{i} )}^{T} {\sum }_{a}^{- 1} ( {μ}_{a} - {μ}_{i} ) ) ,$$

where the logarithm is taken with base e. The pose encoder and identity encoder do not have access to other modality information in their inputs, so they can only learn their target modalities.

Media generation system 1300 combines all three modalities using conditional attention network 1360 followed by conditional image decoder 1365 to generate synthetic image 1370 (I). The media generation system, at training, tries to bring I close to I_{gt} using a weighted combination of mean square error (MSE), multi-scale structural similarity index measure (MS-SSIM), and Perceptual losses:

ReconLoss=λ_{MSE}*MSE(I,I_{gt})+λₘₛₛᵢₘ*MSSSIM(I,I_{gt})+λ_{percep}*Percep(I,Igt) (8)

The Recon Loss ensures that each encoder efficiently captures its target modality so that I can be accurately reconstructed close to I_{gt} using α, δ, and P (referring to FIG. 5). The media generation system 1300 also computes an adversarial loss Adv Loss, where the model jointly trains a typical image discriminator D to distinguish between I and I_{gt}. In some cases, adversarial loss Adv Loss is denoted as “Disc” in FIG. 13. Loss function 1345 looks like the following:

FinalLoss=λ_{kid}*KLDLOSS+λ_{recon}*ReconLoss+λ_{adv}*AdvLoss (9)
where λ, are hyper-parameter loss weights for different losses.

Conditional attention network 1360 is an example of, or includes aspects of, the corresponding element described with reference to FIGS. 4-5 and 7. Conditional image decoder 1365 is an example of, or includes aspects of, the corresponding element described with reference to FIGS. 4-5 and 7. Synthetic image 1370 is an example of, or includes aspects of, the corresponding element described with reference to FIG. 5.

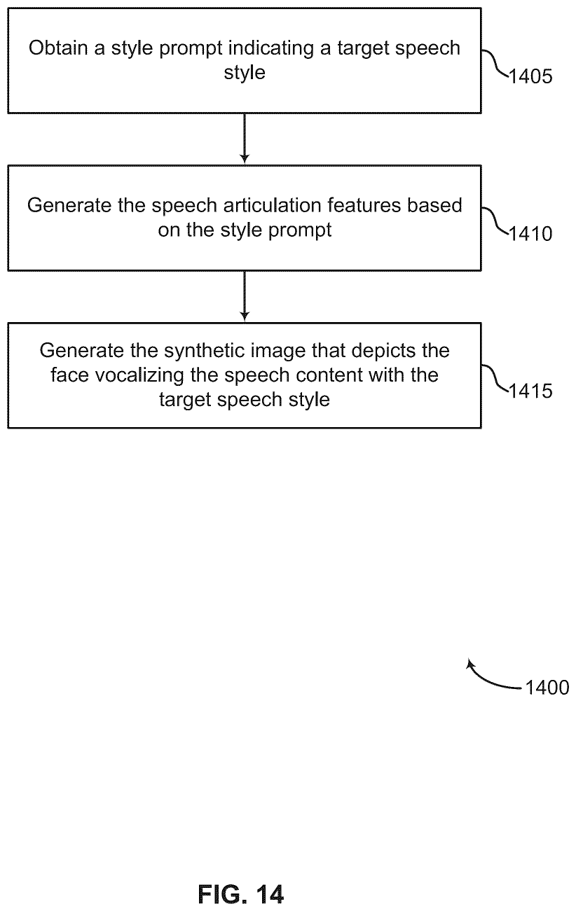

FIG. 14 shows an example of a method 1400 for media processing with style prompt according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1405, the system obtains a style prompt indicating a target speech style. In some cases, the operations of this step may be performed by a style adaptor as described with reference to FIGS. 4, 6, and 11. For example, at inference, style adaptor 630 obtains a style prompt 625 indicating a target speech style.

At operation 1410, the system generates the speech articulation features based on the style prompt. In some cases, the operations of this step may be performed by an audio-to-speech-articulation model as described with reference to FIGS. 4-6, and 11. For example, audio-to-speech-articulation model 525 operates to generate the speech articulation features 540 based on the style prompt.

At operation 1415, the system generates the synthetic image that depicts the face vocalizing the speech content with the target speech style. In some cases, the operations of this step may be performed by a media generation system as described with reference to FIGS. 4, 5, and 13. In some embodiments, the synthetic image is referred to as a lipsync image, and facial expression of the face depicted is harmonious and compatible with the vocalization.

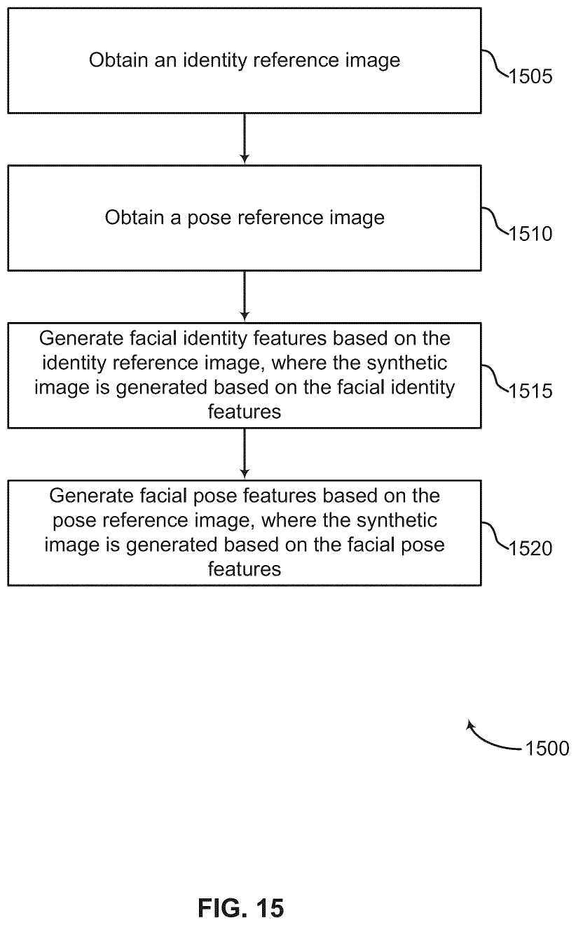

FIG. 15 shows an example of a method 1500 for media processing with identity and pose references according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1505, the system obtains an identity reference image. In some cases, the operations of this step may be performed by an identity encoder as described with reference to FIGS. 4, 5, and 13. For example, identity encoder 535 obtains identity reference image 520.

At operation 1510, the system obtains a pose reference image. In some cases, the operations of this step may be performed by a pose encoder as described with reference to FIGS. 4, 5, and 13. For example, pose encoder 530 obtains pose reference image 515.

At operation 1515, the system generates facial identity features based on the identity reference image, where the synthetic image is generated based on the facial identity features. In some cases, the operations of this step may be performed by an identity encoder as described with reference to FIGS. 4, 5, and 13. For example, identity encoder 535 generates facial identity features or identity embeddings based on identity reference image 520, the facial identity features used by downstream components such as conditional attention network 545 followed by conditional image decoder 550 to generate synthetic image 555.

At operation 1520, the system generates facial pose features based on the pose reference image, where the synthetic image is generated based on the facial pose features. In some cases, the operations of this step may be performed by a pose encoder as described with reference to FIGS. 4-5, and 13. For example, pose encoder 530 generates facial pose features or pose embeddings based on pose reference image 515, the facial pose features used by downstream components such as conditional attention network 545 followed by conditional image decoder 550 to generate synthetic image 555. In some embodiments, by performing operations described herein, media generation system 500 disentangles speech-articulation, identity, and pose modalities and generates synthetic images that more accurately depicts a face with the facial expression vocalizing the speech content included in the input prompt.

FIG. 16 shows an example of a data extraction network 1600 for data extraction in media processing according to embodiments of the present disclosure. The example shown includes data extraction network 1600, unconstrained video 1605, scene segmentation 1610, set of scenes 1615, active speaker detection 1620, active speakers 1625, HUBERT features extraction 1630, crop-based frames extraction 1635, key point detection 1640, and data 1645.

FIG. 16 shows a detailed view of the data extraction network (or a data extractor). In FIG. 16, scene segmentation 1610 operates on unconstrained video 1605, typically an unconstrained video (e.g. raw video data with no key points specified in depicted faces), to obtain a set of scenes 1615. Active speaker detection 1620 operates on each of the set of scenes 1615 to detect active speakers 1625 for each scene. HuBERT features extraction 1630 operates on each scene with corresponding active speakers 1625 detected, generating a corresponding audio data; crop-based frames extraction 1635 operates on each scene with corresponding active speakers 1625 detected, obtaining e.g. a corresponding cropped image depicting the corresponding active speaker(s). Key point detection 1640 operates on each cropped image and generates an image with key points detected. Each image with key points detected (e.g. as facial expression data, referring to FIGS. 4-6 and 9-13), together with its corresponding audio data, constitute a data 1645 or a data point thereof.

In more details, given an unconstrained video (e.g. unconstrained video 1605), data extraction network 1600 first performs content-based scene segmentation (scene segmentation 1610) to split the video into individual scenes based on the visual and temporal continuity. For each scene, data extraction network 1600 employs S3FD for robust face detection to identify facial bounding boxes in each frame. These bounding boxes are then used to establish temporal face tracks, ensuring consistent identity tracking across the scene.

Data extraction network 1600 applies active speaker detection 1620 (ASD) on each face track (e.g. each of the set of scenes 1615) to verify lipsync consistency with the audio stream. Tracks that demonstrate proper audio-visual synchronization are stored as subscenes, which can be used either for training or for subsequent lipsync modification. Along with the video segments, data extraction network 1600 stores essential metadata that enables seamless reintegration of edited content back into the original video.

For each subscene, data extraction network 1600 extracts comprehensive facial information using a combination of 2D landmarks and 3D face alignment. The corresponding audio segments are processed to extract HuBERT features e.g. via HUBERT features extraction 1630 operation, which provide speaker-agnostic speech content representations. In some examples, HUBERT features extraction 1630 removes speaker identities and keeps content (e.g. in audio modality).

Pre-computed features as described above serve as the foundation for all subsequent audio processing steps in the pipeline, for example at training. The systematic design of data extraction network 1600 enables the processing of diverse video formats including movie scenes, interviews, and podcasts. Data extraction network 1600 facilitates the creation of high-quality training datasets while maintaining content fidelity. Data extraction network 1600 can detect potential audio-visual synchronization inconsistencies that might indicate prior manipulation. Data extraction network 1600 ensures efficient parallel processing through its distributed architecture.

In some embodiments, data extraction network 1600 is represented as X-tractor. For preparation of training dataset, unconstrained video dataset (e.g. unconstrained video 1605 before processing by data extraction network 1600) contains around 6 k samples with an average duration of 10 seconds. The unconstrained video dataset is the training dataset. The dataset was processed using the X-tractor pipeline, and the processed data was used to train both SpArtN (e.g. media generation system 1300) and Audio2SpArt (e.g. audio-to-speech-articulation model 1100) networks. It is not necessary to train both networks on the same data. In some embodiments, alternatively or additionally, data 1645 or audio data included therein can be used at inference.

Data extraction network 1600 is an example of, or includes aspects of, the corresponding element described with reference to FIG. 4. HuBERT features extraction 1630, active speaker detection 1620 and key point detection 1640 are typically examples of neural network based operations. Crop-based frames extraction 1635 is typically an example of a learning-free operation.

In some embodiments, key point detection 1640 detects a number of key points (i.e. key facial locations on a face for identifying speech expression features) for each active speaker of a corresponding scene; in some cases, the number of key points is 68 for each active speaker of each corresponding scene. Data 1645 is an example of, or includes aspects of, the corresponding element(s) as described with reference to FIGS. 9-13.

In FIGS. 9-16, a method, apparatus, non-transitory computer readable medium, and system for training a machine learning model is described. One or more embodiments of the method, apparatus, non-transitory computer readable medium, and system include obtaining a training set including audio data and facial expression data; generating predicted speech articulation features based on the audio data; and training, using the facial expression data and the predicted speech articulation features, an audio-to-speech-articulation model to generate speech articulation features corresponding to the audio data.

In some examples of the method, apparatus, non-transitory computer readable medium, and system, training the audio-to-speech-articulation model includes generating facial expression features based on the facial expression data. In some examples, training the audio-to-speech-articulation model further includes computing a loss function by comparing the predicted speech articulation features to the facial expression features. In some examples, training the audio-to-speech-articulation model further includes updating parameters of the audio-to-speech-articulation model based on the loss function.

Some examples of the method, apparatus, non-transitory computer readable medium, and system further include training a media generation model to generate a synthetic image based on the speech articulation features.

### Training and Evaluation

FIG. 17 shows an example of a procedure for training a machine learning model according to embodiments of the present disclosure. In some embodiments, the procedure 1700 describes an operation of the training component 475 for configuring or fine-tuning the media generation system 425 with reference to FIG. 4. The procedure 1700 provides one or more examples of generating training data, use of the training data to train a machine learning model, and use of the trained machine learning model to perform a task.

To begin in this example, a machine-learning system collects training data (block 1702) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1704) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1706). Initialization of the machine-learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1710). The loss function is utilized to measure a difference between an output of the machine-learning model (i.e., predictions) and target values (e.g., as expressed by the training data) to be used to train the machine-learning model. Additionally, an optimization algorithm is selected (block 1712) to be used in conjunction with the loss function to optimize parameters of the machine-learning model during training, examples of which include gradient descent, stochastic gradient descent (SGD), Adam, AdamW, and so forth.

Initialization of the machine-learning model further includes setting hyperparameters (block 1714) and setting initial values (block 1716) of the machine-learning model, examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a set of nodes that collectively form a set of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1720), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), the procedure 1700 continues training of the machine-learning model using the training data (block 1718) in this example.

If the stopping criterion is met (“yes” from decision block 1720), the trained machine-learning model is then utilized to generate an output based on subsequent data (block 1722). The trained machine-learning model, for instance, is trained to perform a task as described above and therefore, once trained is configured to perform that task based on subsequent data received as an input and processed by the machine-learning model.

FIG. 18 shows an example of a computing device for image processing according to embodiments of the present disclosure. The computing device 1800 may be an example of the media processing apparatus 400 described with reference to FIG. 4. In some embodiments, computing device 1800 includes one or more processors 1805, memory subsystem 1810, communication interface 1815, I/O interface 1820, user interface component(s) 1825, and channel 1830.

In some embodiments, computing device 1800 is an example of, or includes aspects of, the media generation system of FIGS. 4-5 and 13. In some embodiments, computing device 1800 includes one or more processors 1805 that can execute instructions stored in memory subsystem 1810 to perform media generation.

According to some aspects, computing device 1800 includes one or more processors 1805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In some embodiments, memory subsystem 1810 includes dedicated memories that store model parameters that, when combined with operations executed by one or more processors 1805, cause corresponding components to perform the functions described for example as described with reference to FIGS. 2-6 and 9-16. In some embodiments, the dedicated memories are implemented as non-transitory computer-readable mediums. The parameters may be stored statically or configured at runtime. For example, adjustments to the parameters may be made during pretraining processes, finetuning processes, or user-configuration processes such as hot-swapping different models. In some implementations or embodiments, these dedicated memories include specialized memory structures enable hardware-accelerated execution of complex computational functions through purpose-built circuitry optimized for specific operations, thereby transforming a general purpose computing device into a specialized machine such as computing device 1800 configured to perform the particular media processing operations described herein, e.g. with reference to FIGS. 2-6 and 9-16. The dedicated memories may be coupled with specialized processing units, such as tensor processing units or neural processing units, which implement custom data paths specifically designed to execute the operations required by the media processing components.

According to some aspects, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or via hardware components controlled by the I/O controller.

According to some aspects, user interface component(s) 1825 enable a user to interact with computing device 1800. In some cases, user interface component(s) 1825 include an audio device, such as an external speaker system, an external display device such as a display screen, an input device (e.g., a remote-control device interfaced with a user interface directly or through the I/O controller), or a combination thereof. In some cases, user interface component(s) 1825 include a GUI.

Performance of apparatus, systems, non-transitory computer readable media, and methods of the present disclosure has been evaluated, and results indicate embodiments of the present disclosure have obtained increased performance over conventional technology. Example experiments demonstrate that the media processing apparatus and the media generation system described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt including speech content;
generating, using an audio-to-speech-articulation model, speech articulation features based on the input prompt, wherein the speech articulation features represent a facial expression corresponding to the speech content; and
generating, using a media generation model, a synthetic image based on the speech articulation features, wherein the synthetic image depicts a face with the facial expression vocalizing the speech content.

2. The method of claim 1, wherein:
the input prompt comprises an audio modality.

3. The method of claim 1, further comprising:
obtaining a text prompt; and
converting the text prompt to an audio modality.

4. The method of claim 1, further comprising:
obtaining a style prompt indicating a target speech style, wherein the speech articulation features are based on the style prompt, and wherein the synthetic image depicts the face vocalizing the speech content with the target speech style.

5. The method of claim 1, wherein generating the synthetic image comprises:
generating a synthetic video based on the speech articulation features, wherein the synthetic image comprises a frame of the synthetic video.

6. The method of claim 5, wherein:
the synthetic video is synchronized with an audio track of the speech content.

7. The method of claim 1, wherein generating the synthetic image comprises:
decoding the speech articulation features and an attention output from a conditional attention model.

8. The method of claim 1, wherein:
the media generation model is trained using audio data and facial expression data extracted from a training video.

9. The method of claim 1, wherein:
the media generation model is trained using an image-to-speech-articulation model.

10. The method of claim 1, wherein:
the audio-to-speech-articulation model is trained using an image-to-speech-articulation model.

11. The method of claim 1, further comprising:
obtaining an identity reference image; and
generating facial identity features based on the identity reference image, wherein the synthetic image is generated based on the facial identity features.

12. The method of claim 1, further comprising:
obtaining a pose reference image; and
generating facial pose features based on the pose reference image, wherein the synthetic image is generated based on the facial pose features.

13. A method of training a machine learning model, the method comprising:
obtaining a training set including audio data and facial expression data;
generating predicted speech articulation features based on the audio data; and
training, using the facial expression data and the predicted speech articulation features, an audio-to-speech-articulation model to generate speech articulation features corresponding to the audio data.

14. The method of claim 13, wherein training the audio-to-speech-articulation model comprises:
generating facial expression features based on the facial expression data;
computing a loss function by comparing the predicted speech articulation features to the facial expression features; and
updating parameters of the audio-to-speech-articulation model based on the loss function.

15. The method of claim 13, further comprising:
training a media generation model to generate a synthetic image based on the speech articulation features.

16. A system comprising:
a memory component; and
a processing device coupled to the memory component, the processing device configured to perform operations comprising:
obtaining an input prompt including speech content;
generating, using an audio-to-speech-articulation model, speech articulation features based on the input prompt, wherein the speech articulation features represent a facial expression corresponding to the speech content; and
generating, using a media generation model, a synthetic image based on the speech articulation features, wherein the synthetic image depicts a face with the facial expression vocalizing the speech content.

17. The system of claim 16, wherein:
the audio-to-speech-articulation model comprises a one-dimensional (1D) conditional convolution model.

18. The system of claim 16, wherein:
the media generation model comprises a variational autoencoder (VAE).

19. The system of claim 16, further comprising:
an identity encoder configured to generate facial identity features based on an identity reference image, wherein the synthetic image is generated based on the facial identity features.

20. The system of claim 16, further comprising:
a pose encoder configured to generate facial pose features based on a pose reference image, wherein the synthetic image is generated based on the facial pose features.
